(19) United States
(12) Patent Application Publication
(10) Pub. No.: US 2023/0098900 A1
(43) Pub. Date: Mar. 30, 2023

(54) ELECTROSTATIC IMAGE DEVELOPING TONER, ELECTROSTATIC IMAGE DEVELOPER, TONER CARTRIDGE, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Kazutsuna SASAKI, Kanagawa (JP); Atsushi Sugawara, Kanagawa (JP); Yoshimasa Fujihara, Kanagawa (JP); Takashi Inukai, Kanagawa (JP)

(73) Assignee: FUJIFILM Business Innovation Corp., Tokyo (JP)

(21) Appl. No.: 17/707,422

(22) Filed: Mar. 29, 2022

(30) Foreign Application Priority Data
Sep. 24, 2021 (JP) 2021-156203

(51) Int. Cl. G03G 9/087; G03G 15/08; G03G 21/18

(52) U.S. Cl. CPC G03G 9/08711; G03G 9/08782; G03G 15/0867; G03G 21/1814

(57) ABSTRACT

An electrostatic image developing toner includes toner particles containing a binder resin and a release agent. In sections of the toner particles in which the sections of the toner particles have an area St in total and, among sections of domains of the release agent, sections of domains having long diameters of 10 nm or more and 500 nm or less have a total area Sa and sections of domains having long diameters of 1500 nm or more and 3000 nm or less have a total area Sb, an area fraction Sa/St is 2% or more and an area fraction Sb/St is 20% or more.

### CROSS-REFERENCE TO RELATED APPLICATIONS

This application is based on and claims priority under 35 USC 119 from Japanese Patent Application No. 2021-156203 filed Sep. 24, 2021.

### BACKGROUND

### (i) Technical Field

The present disclosure relates to an electrostatic image developing toner, an electrostatic image developer, a toner cartridge, a process cartridge, an image forming apparatus, and an image forming method.

### (ii) Related Art

Japanese Unexamined Patent Application Publication No. 2011-197205 discloses an electrostatic image developing toner including at least a binder resin and a release agent, wherein the release agent is contained as domains having diameters of 10 nm or more and 500 nm or less, and the release agent contains, in the domains, fibers.

### SUMMARY

In the case of using an electrostatic image developing toner to form an image, for example, a toner image having been transferred onto a recording medium is heated while being in contact with a fixing member, to thereby be fixed on the recording medium. When the toner image is fixed on the recording medium while being in contact with the fixing member to provide a fixed image, the fixed image may be easily releasable from the fixing member.

A method of improving the releasability of the fixed image is, for example, a method of using an electrostatic image developing toner in which a release agent is dispersed in toner particles such that the domains of the release agent contained in the toner particles have small long diameters.

However, in the case of using an electrostatic image developing toner including toner particles in which domains of the release agent have small long diameters to continuously form images having a low area coverage in a low-temperature and low-humidity environment (for example, in an environment at a temperature of 10° C. and at a humidity of 15%), a decrease in the image density may be caused.

Aspects of non-limiting embodiments of the present disclosure relate to providing an electrostatic image developing toner that achieves, compared with a case where an area fraction Sa/St is less than 2%, an area fraction Sb/St is less than 20%, Na is less than 15, or Nb is less than 3, both of the releasability of the fixed image and, in the case of continuously forming images in a low-temperature and low-humidity environment, suppression of the decrease in the image density.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electrostatic image developing toner including toner particles containing a binder resin and a release agent, wherein, in sections of the toner particles in which the sections of the toner particles have an area St in total and, among sections of domains of the release agent, sections of domains having long diameters of 10 nm or more and 500 nm or less have a total area Sa and sections of domains having long diameters of 1500 nm or more and 3000 nm or less have a total area Sb, an area fraction Sa/St is 2% or more and an area fraction Sb/St is 20% or more.

### BRIEF DESCRIPTION OF THE DRAWINGS

Exemplary embodiments of the present disclosure will be described in detail based on the following figures, wherein:

FIG. 1 is a schematic configuration view illustrating an example of an image forming apparatus according to an exemplary embodiment; and

FIG. 2 is a schematic configuration view illustrating an example of a process cartridge attachable to and detachable from an image forming apparatus according to an exemplary embodiment.

### DETAILED DESCRIPTION

Hereinafter, exemplary embodiments serving as examples of the present disclosure will be described. Such descriptions and Examples are mere examples of exemplary embodiments and do not limit the scope of the disclosure.

In this Specification, among numerical ranges described in series, the upper limit value or the lower limit value of a numerical range may be replaced by the upper limit value or the lower limit value of one of other numerical ranges described in series. For numerical ranges described in this Specification, the upper limit value or the lower limit value of such a numerical range may be replaced by a value described in Examples.

In this Specification, (meth)acrylic means both of acrylic and methacrylic. In this Specification, the (meth)acryloyl group means both of the acryloyl group and the methacryloyl group.

In this Specification, the term “step” includes not only an independent step, but also a step that is not clearly distinguished from another step but that achieves the intended result of the step.

Components may each include plural corresponding substances.

In the case of referring to the amount of each of components in a composition, the amount means, when the composition contains plural substances belonging to such a component, the total amount of the plural substances in the composition unless otherwise specified.

### Electrostatic Image Developing Toner

### First Exemplary Embodiment

An electrostatic image developing toner according to a first exemplary embodiment (hereafter, also referred to as “toner”) includes toner particles containing a binder resin and a release agent, wherein, in sections of the toner particles in which the sections of the toner particles have an area St in total and, among sections of domains of the release agent, sections of domains having long diameters of 10 nm or more and 500 nm or less have a total area Sa and sections of domains having long diameters of 1500 nm or more and 3000 nm or less have a total area Sb, an area fraction Sa/St is 2% or more and an area fraction Sb/St is 20% or more.

The toner according to the first exemplary embodiment has such features, which may result in achievement of both of the releasability of the fixed image and, in the case of continuously forming images in a low-temperature and low-humidity environment, suppression of the decrease in the image density. The reason for this has not been clarified, but is inferred as follows.

As described above, the method of improving the releasability of the fixed image is, for example, a method of using an electrostatic image developing toner in which a release agent is dispersed in toner particles such that the domains of the release agent contained in the toner particles have small long diameters. Hereafter, the domains of the release agent will also be referred to as “release-agent domains”, and the long diameters of the release-agent domains will also be referred to as “release-agent domain diameters”.

When the release-agent domain diameters are small, heating during fixing facilitates exudation of the release-agent domains within the toner particles to the surfaces of the toner particles, which inferentially improves the releasability of the fixed image.

However, in the case of using a toner including toner particles having small release-agent domain diameters to continuously form images having a low area coverage, the toner is stirred in the toner containing part in the developing section, which applies a load to the toner and may cause breakage of the toner particles. In particular, in the case of continuously forming images having a low area coverage in a low-temperature and low-humidity environment, the probability of the breakage of the toner particles becomes high.

The toner having breakage has low fluidity and hence has a small triboelectric charge amount; thus, use of the toner having breakage for forming an image may result in a decrease in the image density.

By contrast, in the first exemplary embodiment, the toner particles have an area fraction Sa/St of 2% or more and an area fraction Sb/St of 20% or more. In other words, in the first exemplary embodiment, the toner particles include both of a release-agent domain having a release-agent domain diameter of 10 nm or more and 500 nm or less (hereafter, also referred to as “small-diameter domain”) and a release-agent domain having a release-agent domain diameter of 1500 nm or more and 3000 nm or less (hereafter, also referred to as “large-diameter domain”).

The large-diameter domains are, compared with the small-diameter domains, less likely to exude to the surfaces of the toner particles during fixing, but are more flexible than the binder resin and hence inferentially tend to serve as a cushioning material during collision between toner particles due to a load from the outside. Thus, in the toner according to the first exemplary embodiment, inferentially, during fixing, the small-diameter domains may be likely to exude to the surfaces of the toner particles and, during stirring in the toner containing part in the developing section, the large-diameter domains may play the role of a cushioning material to suppress breakage of the toner particles. In this way, the first exemplary embodiment inferentially may achieve both of the releasability of the fixed image and, in the case of continuously forming images in a low-temperature and low-humidity environment, suppression of the decrease in the image density.

Note that the toner particles obtained by the related-art technique of increasing the diameters of the release-agent domains are different, at least in that the area fraction Sa/St is out of the above-described range, from the toner particles in the first exemplary embodiment. In addition, the toner particles obtained by the related-art technique of decreasing the diameters of the release-agent domains are different, at least in that the area fraction Sb/St is out of the above-described range, from the toner particles in the first exemplary embodiment.

### Second Exemplary Embodiment

A toner according to a second exemplary embodiment includes toner particles containing a binder resin and a release agent, wherein, per section of one of the toner particles in which, among sections of domains of the release agent, a number of sections of domains having long diameters of 10 nm or more and 500 nm or less is Na and a number of sections of domains having long diameters of 1500 nm or more and 3000 nm or less is Nb, Na is 15 or more and Nb is 3 or more.

The toner according to the second exemplary embodiment has such features, which may result in achievement of both of the releasability of the fixed image and, in the case of continuously forming images in a low-temperature and low-humidity environment, suppression of the decrease in the image density.

As described above, when the release-agent domain diameters are small, as a result of heating during fixing, the release-agent domains within the toner particles tend to exude to the surfaces of the toner particles, which inferentially results in improved releasability of the fixed image. However, when the release-agent domain diameters are small, in the case of continuously forming images having a low area coverage in a low-temperature and low-humidity environment, breakage of the toner particles may cause a decrease in the image density.

By contrast, in the second exemplary embodiment, Na is 15 or more and Nb is 3 or more. In other words, in the second exemplary embodiment, the toner particles include both of the small-diameter domain and the large-diameter domain. Thus, also in the second exemplary embodiment, as in the first exemplary embodiment, inferentially, during fixing, the small-diameter domains may be likely to exude to the surfaces of the toner particles and, during stirring in the toner containing part of the developing section, the large-diameter domains may play the role of a cushioning material to suppress breakage of the toner particles. As a result, the second exemplary embodiment inferentially may achieve both of the releasability of the fixed image and, in the case of continuously forming images in a low-temperature and low-humidity environment, suppression of the decrease in the image density.

Note that the toner particles obtained by the related-art technique of increasing the diameters of the release-agent domains are different, at least in that Na is out of the above-described range, from the toner particles in the second exemplary embodiment. In addition, the toner particles obtained by the related-art technique of decreasing the diameters of the release-agent domains are different, at least in that Nb is out of the above-described range, from the toner particles in the second exemplary embodiment.

Hereinafter, a toner belonging to both of the toner according to the first exemplary embodiment and the toner according to the second exemplary embodiment will be referred to as “the toner according to the present exemplary embodiment” and described. However, an example of the toner according to the present disclosure is a toner that belongs to at least one of the toner according to the first exemplary embodiment or the toner according to the second exemplary embodiment.

### Release-Agent Domains

### Measurement Method

The release-agent domains are observed in the following manner.

The toner particles (or toner particles to which an external additive adheres) are mixed with an epoxy resin and embedded, and the epoxy resin is solidified. The resultant solidified material is cut with an ultramicrotome apparatus (Ultracut UCT manufactured by Leica Microsystems GmbH), to prepare a thin slice sample having a thickness of 80 nm or more and 130 nm or less. Subsequently, the obtained thin slice sample is stained within a desiccator at 30° C. using ruthenium tetraoxide for 3 hours. Subsequently, an ultrahigh-resolution field-emission scanning electron microscope (FE-SEM: S-4800 manufactured by Hitachi High-Technologies Corporation) is used to provide a STEM observation image of the stained thin slice sample in the transmission image mode (acceleration voltage: 30 kV, magnification: 20000×).

From the contrast and shapes in the obtained STEM observation image, the contours of the release-agent domains in the toner particles are determined. In the STEM image, the binder resin other than the release agent has a large number of double bond moieties and is stained with ruthenium tetraoxide; thus, the release agent region and the binder resin region other than the release agent are differentiated.

Specifically, as a result of ruthenium staining, the release agent is the most lightly stained domains and the amorphous resin is most darkly stained. The contrast is adjusted, so that the release agent looks white and the amorphous resin looks black, which defines the shapes of sections of the release-agent domains.

Toner particles (100 particles) are observed and the regions of release-agent domains are subjected to image analysis, to thereby determine the release-agent domain diameter of each release-agent domain, the area of the section of each release-agent domain, and the area of the section of each toner particle. These results are used to calculate the total area St of sections of the toner particles observed, the total area Sa of sections of small-diameter domains, the total area Sb of sections of large-diameter domains, the average number Na of small-diameter domains per toner particle, the average number Nb of large-diameter domains per toner particle, and the total area Sw of the release-agent domains as a whole.

Note that the STEM image includes toner particle sections of various sizes; toner particle sections having diameters of 70% or more of the volume-average particle diameter of the toner particles are selected as toner particles for observation. The diameter of such a toner particle section means the maximum length of straight lines drawn between any two points on the contour of the toner particle section (namely, the long diameter).

### Area Fraction

In the present exemplary embodiment, as described above, the area fraction Sa/St, which is 2% or more, is, from the viewpoint of providing high releasability of the fixed image, preferably 2.5% or more, more preferably 3% or more.

The area fraction Sa/St is, from the viewpoint of suppressing the decrease in the toner fluidity caused by exudation of the release agent to the surfaces of the toner particles due to the load during stirring of the toner within the developing section, preferably 20% or less, more preferably 18% or less, still more preferably 15% or less.

The area fraction Sa/St is preferably 2% or more and 20% or less, more preferably 2.5% or more and 18% or less, still more preferably 3% or more and 15% or less.

The area fraction Sb/St, which is, as described above, 20% or more, is, from the viewpoint of suppressing the decrease in the image density in the case of continuously forming images in a low-temperature and low-humidity environment, preferably 23% or more, more preferably 26% or more.

The area fraction Sb/St is, from the viewpoint of suppressing the decrease in the toner fluidity caused by exudation of the release agent to the surfaces of the toner particles due to the load during stirring of the toner within the developing section, preferably 40% or less, more preferably 38% or less, still more preferably 36% or less.

The area fraction Sb/St is preferably 20% or more and 40% or less, more preferably 23% or more and 38% or less, still more preferably 26% or more and 36% or less.

The ratio Sb/Sa is, from the viewpoint of achieving both of the releasability of the fixed image and suppressing the decrease in the image density in the case of continuously forming images in a low-temperature and low-humidity environment, preferably 1 or more and 20 or less, more preferably 1 or more and 15 or less, still more preferably 1 or more and 12 or less.

Note that, among the sections of the release-agent domains in which the sections of domains having long diameters of more than 500 nm and less than 1500 nm (hereafter, also referred to as “medium-diameter domains”) have a total area Sc, the value of an area fraction Sc/St is not particularly limited. The area fraction Sc/St may be 1% or less, may be 1% or more and 5% or less, or may be 1% or more and 10% or less.

The total area Sc may be smaller than the total area Sa, and may be smaller than the total area Sb. A ratio Sc/Sa may be less than 1, may be 0.1 or more and less than 1, or may be 0.2 or more and 0.8 or less. A ratio Sc/Sb may be less than 1, may be 0.05 or more and less than 1, or may be 0.05 or more and 0.3 or less.

When the sections of the release-agent domains have a total area defined as Sw, the value of (Sa+Sb)/Sw may be 0.9 or more, may be 0.93 or more, or may be 1.

An area fraction Sw/St is preferably 30% or more and 50% or less, more preferably 35% or more and 50% or less, still more preferably 35% or more and 45% or less.

The case where the area fraction Sw/St is in such a range, compared with a case where the area fraction Sw/St is smaller than such a range, provides achievement both of the releasability of the fixed image and suppression of the decrease in the image density in the case of continuously forming images in a low-temperature and low-humidity environment. The case where the area fraction Sw/St is in such a range, compared with a case where the area fraction Sw/St is larger than such a range, achieves suppression of the decrease in the toner fluidity caused by exudation of the release agent to the surfaces of the toner particles due to the load during stirring of the toner within the developing section, and suppression of the decrease in the image density due to the decrease in the toner fluidity.

### Number of Domains

In the present exemplary embodiment, Na, which is, as described above, 15 or more, is, from the viewpoint of providing high releasability of the fixed image, preferably 17 or more, more preferably 20 or more.

Na is, from the viewpoint of suppressing the decrease in the toner fluidity caused by exudation of the release agent to the surfaces of the toner particles due to the load during stirring of the toner within the developing section, preferably 45 or less, more preferably 40 or less, still more preferably 35 or less.

Na is preferably 15 or more and 45 or less, more preferably 17 or more and 40 or less, still more preferably 20 or more and 35 or less.

Nb, which is, as described above, 3 or more, is, from the viewpoint of suppressing the decrease in the image density in the case of continuously forming images in a low-temperature and low-humidity environment, preferably 3.2 or more, more preferably 3.5 or more.

Nb is, from the viewpoint of suppressing the decrease in the toner fluidity caused by exudation of the release agent to the surfaces of the toner particles due to the load during stirring of the toner within the developing section, preferably 5 or less, more preferably 4.8 or less, still more preferably 4.6 or less.

Nb is preferably 3 or more and 5 or less, more preferably 3.2 or more and 4.8 or less, still more preferably 3.5 or more and 4.6 or less.

The ratio Nb/Na is, from the viewpoint of achieving both of the releasability of the fixed image and suppressing the decrease in the image density in the case of continuously forming images in a low-temperature and low-humidity environment, preferably 0.05 or more and 0.30 or less, more preferably 0.05 or more and 0.25 or less, still more preferably 0.1 or more and 0.2 or less.

Note that, when the number of the medium-diameter domains per section of one of the toner particles is defined as Nc, Nc is not particularly limited. Nc may be 3 or less, may be 0.5 or more and 3 or less, or may be 0.5 or more and 2 or less.

Nc may be smaller than Na and may be smaller than Nb. A ratio Nc/Na may be less than 1, may be 0.01 or more and 0.1 or less, or may be 0.01 or more and 0.05 or less. A ratio Nc/Nb may be less than 1, may be 0.05 or more and 0.5 or less, or may be 0.1 or more and 0.3 or less.

When the total of Na, Nb, and Nc is defined as Nw, the value of (Na+Nb)/Nw may be 0.9 or more, may be 0.95 or more, or may be 1.

### Average Circularity of Large-Diameter Domains

The sections of the large-diameter domains preferably have an average circularity of 0.6 or more, more preferably 0.7 or more, still more preferably 0.8 or more, particularly preferably 0.85 or more. In the case where the sections of the large-diameter domains have an average circularity in such a range, compared with a case where the average circularity is smaller than such a range, breakage starting from the interface between a release-agent domain and the binder resin within the toner particles due to the load during stirring of the toner within the developing section may be less likely to occur, which may result in suppression of the decrease in the image density in the case of continuously forming images in a low-temperature and low-humidity environment.

The upper-limit value of the average circularity of the sections of the large-diameter domains is not particularly limited and is, for example, 1.00 or less.

The average circularity of the sections of the large-diameter domains is the number-average circularity of the large-diameter domains in the STEM image; the circularity of each large-diameter domain is determined as a value provided by dividing the equivalent circular circumference (specifically, the circumference of a circle having the same area as the section of the large-diameter domain) by the actual circumference.

### Control of Distribution of Release-Agent Domain Diameters

The method of controlling the distribution of the release-agent domain diameters such that the area fraction Sa/St, the area fraction Sb/St, Na, and Nb satisfy the above-described ranges is not particularly limited.

The method of controlling the distribution of the release-agent domain diameters is, for example, a method of performing an aggregation-coalescence method described later to produce toner particles having a core-shell structure described later in which, as a surfactant used for a release-agent-particle dispersion liquid for forming core portions (hereafter, also referred to as “core particles”), a surfactant having a polarity opposite to that of a surfactant used for a release-agent-particle dispersion liquid for forming cover layers (hereafter, also referred to as “shell layers”) is used (hereafter, also referred to as “opposite-polarity surfactant method”). Specifically, for example, in the case of using, for the core-particle-forming release-agent-particle dispersion liquid, a cationic surfactant, for the shell-layer-forming release-agent-particle dispersion liquid, an anionic surfactant is used. Alternatively, for example, in the case of using, for the core-particle-forming release-agent-particle dispersion liquid, an anionic surfactant, for the shell-layer-forming release-agent-particle dispersion liquid, a cationic surfactant is used.

The reason why the opposite-polarity surfactant method achieves control of the distribution of the release-agent domain diameters has not been clarified, but is inferred as follows.

For example, when a resin-particle dispersion liquid in which particles of a binder resin are dispersed contains an anionic surfactant, a release-agent-particle dispersion liquid containing a cationic surfactant is used to form core particles, so that the release-agent domain diameters within the core particles decrease. Specifically, the polarity of the resin particles and the polarity of the release-agent particles are opposite to each other, so that the resin particles and the release-agent particles have high affinity for each other and, in the process of aggregation, the resin particles surround the release-agent particles to suppress aggregation among the release-agent particles, which inferentially results in the decrease in the release-agent domain diameters. Subsequently, a resin-particle dispersion liquid containing an anionic surfactant and a release-agent-particle dispersion liquid containing an anionic surfactant are used to form shell layers on the surfaces of the core particles, so that the release-agent domain diameters within the shell layers are larger than the release-agent domain diameters within the core particles. Thus, within such a toner particle, release-agent domains having large release-agent domain diameters and release-agent domains having small release-agent domain diameters are present. As a result, inferentially, the area fraction Sa/St, the area fraction Sb/St, Na, and Nb are controlled to satisfy the above-described ranges.

Hereinafter, as an example of the toner according to the present exemplary embodiment, a toner in which the opposite-polarity surfactant method is used to control the distribution of the release-agent domain diameters will be described in detail.

The toner according to the present exemplary embodiment includes toner particles and, as needed, an external additive.

### Toner Particles

The toner particles include, for example, a binder resin, a release agent, and, as needed, a coloring agent and another additive.

### Binder Resin

Examples of the binder resin include vinyl-based resins formed of homopolymers of monomers such as styrenes (for example, styrene, para-chlorostyrene, and α-methylstyrene), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (for example, acrylonitrile and methacrylonitrile), vinyl ethers (for example, vinyl methyl ether and vinyl isobutyl ether), vinyl ketones (for example, vinyl methyl ketone, vinyl ethyl ketone, and vinyl isopropenyl ketone), and olefins (for example, ethylene, propylene, and butadiene), or copolymers that are combinations of two or more species of these monomers.

Other examples of the binder resin include non-vinyl-based resins such as epoxy resins, polyester resins, polyurethane resins, polyamide resins, cellulose resins, polyether resins, and modified rosin, mixtures of the foregoing and the above-described vinyl-based resins, and graft polymers obtained by polymerizing, in the presence of the foregoing, vinyl-based monomers.

Such binder resins may be used alone or in combination of two or more thereof.

Of the above-described examples, from the viewpoint of having low-temperature fixability, the binder resin preferably includes a styrene-(meth)acrylic resin obtained by copolymerizing a monomer having a styrene skeleton and a monomer having a (meth)acrylic acid ester skeleton.

Toner particles in which the binder resin includes a styrene-(meth)acrylic resin tend to form wax domains having small diameters to increase the wax-resin interfaces, which tends to result in breakage due to a load from the outside. However, in the present exemplary embodiment, the presence of the large-diameter domains within the toner particles may suppress breakage of the toner particles, which may result in achievement of both of the releasability of the fixed image and, in the case of continuously forming images in a low-temperature and low-humidity environment, suppression of the decrease in the image density.

The styrene-(meth)acrylic resin is a copolymer provided by copolymerizing at least a monomer having a styrene skeleton and a monomer having a (meth)acryloyl group.

Examples of the monomer having a styrene skeleton (hereafter, also referred to as “styrene-based monomer”) include styrene, alkyl-substituted styrenes (for example, α-methylstyrene, 2-methylstyrene, 3-methylstyrene, 4-methylstyrene, 2-ethylstyrene, 3-ethylstyrene, and 4-ethylstyrene), halogen-substituted styrenes (for example, 2-chlorostyrene, 3-chlorostyrene, and 4-chlorostyrene), and vinylnaphthalene. Such styrene-based monomers may be used alone or in combination of two or more thereof.

Of these, the styrene-based monomer is, from the viewpoint of reactivity, ease of control of the reaction, and availability, preferably styrene.

Examples of the monomer having a (meth)acryloyl group (hereafter, also referred to as “(meth)acrylic-based monomer”) include (meth)acrylic acid and (meth)acrylic acid esters. Examples of the (meth)acrylic acid esters include (meth)acrylic acid alkyl esters (for example, n-methyl (meth)acrylate, n-ethyl (meth)acrylate, n-propyl (meth)acrylate, n-butyl (meth)acrylate, n-pentyl (meth)acrylate, n-hexyl acrylate, n-heptyl (meth)acrylate, n-octyl (meth)acrylate, n-decyl (meth)acrylate, n-dodecyl (meth) acrylate, n-lauryl (meth) acrylate, n-tetradecyl (meth) acrylate, n-hexadecyl (meth) acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth) acrylate, isooctyl (meth) acrylate, 2-ethylhexyl (meth)acrylate, cyclohexyl (meth)acrylate, and t-butylcyclohexyl (meth)acrylate), (meth)acrylic acid aryl esters (for example, phenyl (meth)acrylate, biphenyl (meth) acrylate, diphenylethyl (meth) acrylate, t-butylphenyl (meth)acrylate, and terphenyl (meth)acrylate), dimethylaminoethyl (meth) acrylate, diethylaminoethyl (meth) acrylate, methoxyethyl (meth) acrylate, 2-hydroxyethyl (meth)acrylate, β-carboxyethyl (meth)acrylate, and (meth)acrylamide. The (meth)acrylic-based monomers may be used alone or in combination of two or more thereof.

The copolymerization ratio of the styrene-based monomer and the (meth)acrylic-based monomer (based on mass, styrene-based monomer/(meth)acrylic-based monomer) is, for example, 85/15 to 70/30.

The styrene-(meth)acrylic resin may have a crosslinked structure. The styrene-(meth)acrylic resin having a crosslinked structure is, for example, a crosslinked resin provided by at least copolymerizing a monomer having a styrene skeleton, a monomer having a (meth)acrylic acid skeleton, and a crosslinkable monomer, to achieve crosslinking.

Examples of the crosslinkable monomer include bi- or higher functional crosslinking agent.

Examples of the bifunctional crosslinking agent include divinylbenzene, divinylnaphthalene, di(meth)acrylate compounds (for example, diethylene glycol di(meth)acrylate, methylenebis(meth)acrylamide, decanediol diacrylate, and glycidyl (meth)acrylate), polyester-type di(meth)acrylate, and 2-([1′-methylpropylideneamino]carboxyamino)ethyl methacrylate.

Examples of the polyfunctional crosslinking agent include tri(meth)acrylate compounds (for example, pentaerythritol tri(meth)acrylate, trimethylolethane tri(meth)acrylate, and trimethylolpropane tri(meth)acrylate), tetra(meth)acrylate compounds (for example, tetramethylolmethane tetra(meth)acrylate, and oligoester (meth)acrylate), 2,2-bis(4-methacryloxy, polyethoxyphenyl)propane, diallyl phthalate, triallyl cyanurate, triallyl asocyanurate, triallyl isocyanurate, triallyl trimellitate, and diallyl chlorendate.

The copolymerization ratio of the crosslinkable monomer to all monomers (based on mass, crosslinkable monomer/all monomers) is, for example, 2/1000 or more and 30/1000 or less.

The styrene-(meth)acrylic resin has a weight-average molecular weight of, from the viewpoint of releasability, for example, 30000 or more and 200000 or less, preferably 40000 or more and 100000 or less, more preferably 50000 or more and 80000 or less.

The weight-average molecular weight of the styrene-(meth)acrylic resin is measured by the same method as in the weight-average molecular weight of a polyester resin described later.

The content of a unit derived from the styrene-based monomer (hereafter, also referred to as “styrene content”) relative to all the toner particles is preferably 15 mass % or more and 25 mass % or less, more preferably 15 mass % or more and 23 mass % or less, still more preferably 17 mass % or more and 22 mass % or less. When the styrene content is in such a range, thermal storability may be provided compared with a case where the styrene content is lower than the range, and low-temperature fixability may be provided compared with a case where the styrene content is higher than the range.

Note that the styrene content means, in a case where, for example, the toner particles include, as the binder resin, plural vinyl-based resins, the total content of units derived from the styrene-based monomers individually included in the plural vinyl-based resins.

Note that the styrene content in the toner particles is determined, after identification of the styrene-based compound by chemical analysis, using a calibration curve of the styrene-based compound measured in advance by liquid chromatography (LC-UV).

The content of the styrene-(meth)acrylic resin relative to the binder resin is, for example, 50 mass % or more and 80 mass % or less, preferably 50 mass % or more and 70 mass % or less, more preferably 60 mass % or more and 70 mass % or less.

The binder resin may contain a polyester resin, and may contain both of a styrene-(meth)acrylic resin and a polyester resin.

Examples of the polyester resin include publicly known amorphous polyester resins. As the polyester resin, an amorphous polyester resin may be used in combination with a crystalline polyester resin. Note that the content of the crystalline polyester resin relative to the whole binder resin may be in the range of 2 mass % or more and 40 mass % or less (preferably 2 mass % or more and 20 mass % or less).

Note that “crystalline” of the resin means that differential scanning calorimetry (DSC) provides not a stepped endothermic change, but a clear endothermic peak, specifically means that measurement at a heating rate of 10(° C./min) provides an endothermic peak having a half width within 10° C.

On the other hand, “amorphous” of the resin means that the half width is more than 10° C., a stepped endothermic change is provided, or a clear endothermic peak is not recognized.

### Amorphous Polyester Resin

Such an amorphous polyester resin is, for example, a polycondensation product between a polycarboxylic acid and a polyhydric alcohol. Note that, as the amorphous polyester resin, a commercially available product may be used or a resin may be synthesized and used.

Examples of the polycarboxylic acid include aliphatic dicarboxylic acids (for example, oxalic acid, malonic acid, maleic acid, fumaric acid, citraconic acid, itaconic acid, glutaconic acid, succinic acid, alkenylsuccinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalene dicarboxylic acid), anhydrides of the foregoing, and lower (for example, 1 or more and 5 or less carbon atoms) alkyl esters of the foregoing. Of these, preferred polycarboxylic acids are, for example, aromatic dicarboxylic acids.

As the polycarboxylic acid, a dicarboxylic acid may be used in combination with a tri- or higher carboxylic acid having a crosslinked structure or a branched structure. Examples of the tri- or higher carboxylic acid include trimellitic acid, pyromellitic acid, anhydrides of the foregoing, and lower (for example, 1 or more and 5 or less carbon atoms) alkyl esters of the foregoing.

Such polycarboxylic acids may be used alone or in combination of two or more thereof.

Examples of the polyhydric alcohol include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, an ethylene oxide adduct of bisphenol A and a propylene oxide adduct of bisphenol A). Of these, as the polyhydric alcohol, for example, preferred are aromatic diols and alicyclic diols, and more preferred are aromatic diols.

As the polyhydric alcohol, a diol may be used in combination with a tri- or higher polyhydric alcohol having a crosslinked structure or a branched structure. Examples of the tri- or higher polyhydric alcohol include glycerol, trimethylolpropane, and pentaerythritol.

Such polyhydric alcohols may be used alone or in combination of two or more thereof.

The amorphous polyester resin has a glass transition temperature (Tg) of preferably 50° C. or more and 80° C. or less, more preferably 50° C. or more and 65° C. or less.

Note that the glass transition temperature is determined on the basis of a DSC curve obtained by differential scanning calorimetry (DSC), more specifically determined in accordance with “extrapolated glass transition onset temperature” described in “How to Determine Glass Transition Temperature” in JIS K 7121-1987 “Testing Methods for Transition Temperatures of Plastics”.

The amorphous polyester resin has a weight-average molecular weight (Mw) of preferably 5000 or more and 1000000 or less, more preferably 7000 or more and 500000 or less.

The amorphous polyester resin preferably has a number-average molecular weight (Mn) of 2000 or more and 100000 or less.

The amorphous polyester resin has a polydispersity index Mw/Mn of preferably 1.5 or more and 100 or less, more preferably 2 or more and 60 or less.

Note that the weight-average molecular weight and the number-average molecular weight are measured by gel permeation chromatography (GPC). The molecular weight measurement by GPC is performed with, as the measurement apparatus, GPCHLC-8120GPC manufactured by Tosoh Corporation, a column TSKgel SuperHM-M (15 cm) manufactured by Tosoh Corporation, and a THF solvent. The weight-average molecular weight and the number-average molecular weight are calculated using molecular weight calibration curves created from the measurement results using monodisperse polystyrene standard samples.

The amorphous polyester resin is obtained by a well-known production method. Specifically, for example, it is obtained by a method in which the polymerization temperature is set at 180° C. or more and 230° C. or less, the pressure within the reaction system is reduced as needed, and the reaction is caused while water or alcohol generated during condensation is removed.

Note that, when monomers serving as raw materials do not dissolve or mix together at the reaction temperature, a solvent having a high boiling point may be added as a solubilizing agent to achieve dissolution. In this case, the polycondensation reaction is caused while the solubilizing agent is driven off. When a monomer having low miscibility is present, the monomer having low miscibility and an acid or alcohol to be subjected to polycondensation with the monomer may be subjected to condensation in advance and then subjected to polycondensation with the main component.

### Crystalline Polyester Resin

The crystalline polyester resin is, for example, a polycondensation product between a polycarboxylic acid and a polyhydric alcohol. Note that the crystalline polyester resin employed may be a commercially available product or may be synthesized.

The crystalline polyester resin is, from the viewpoint of ease of formation of the crystalline structure, preferably a polycondensation product not using an aromatic polymerizable monomer, but using a linear aliphatic polymerizable monomer.

Examples of the polycarboxylic acid include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides of the foregoing, and lower (for example, 1 or more and 5 or less carbon atoms) alkyl esters of the foregoing.

As the polycarboxylic acid, a dicarboxylic acid may be used in combination with a tri- or higher carboxylic acid having a crosslinked structure or a branched structure. Examples of the tricarboxylic acid include aromatic carboxylic acids (for example, 1,2,3-benzenetricarboxylic acid, 1,2,4-benzenetricarboxylic acid, and 1,2,4-naphthalenetricarboxylic acid), anhydrides of the foregoing, and lower (for example, 1 or more and 5 or less carbon atoms) alkyl esters of the foregoing.

As the polycarboxylic acid, such a dicarboxylic acid may be used in combination with a dicarboxylic acid having a sulfonic group or a dicarboxylic acid having an ethylenically double bond.

Such polycarboxylic acids may be used alone or in combination of two or more thereof.

Examples of the polyhydric alcohol include aliphatic diols (for example, linear aliphatic diols having a main-chain moiety having 7 or more and 20 or less carbon atoms). Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Of these, preferred aliphatic diols are 1,8-octanediol, 1,9-nonanediol, and 1,10-decanediol.

As the polyhydric alcohol, a diol may be used in combination with a tri- or higher hydric alcohol having a crosslinked structure or a branched structure. Examples of the tri- or higher hydric alcohol include glycerol, trimethylolethane, trimethylolpropane, and pentaerythritol.

Such polyhydric alcohols may be used alone or in combination of two or more thereof.

For the polyhydric alcohol, the content of the aliphatic diol may be 80 mol % or more, preferably 90 mol % or more.

The crystalline polyester resin has a melting temperature of preferably 50° C. or more and 100° C. or less, more preferably 55° C. or more and 90° C. or less, still more preferably 60° C. or more and 85° C. or less.

Note that the melting temperature is determined, on the basis of a DSC curve obtained by differential scanning calorimetry (DSC), in accordance with “melting peak temperature” described in “How to determine melting temperature” in JIS K7121-1987 “Testing Methods for Transition Temperatures of Plastics”.

The crystalline polyester resin preferably has a weight-average molecular weight (Mw) of 6,000 or more and 35,000 or less.

The crystalline polyester resin is obtained by, for example, as in the amorphous polyester, a well-known production method.

The content of the binder resin is, for example, relative to all the toner particles, preferably 40 mass % or more and 95 mass % or less, more preferably 50 mass % or more and 90 mass % or less, still more preferably 60 mass % or more and 85 mass % or less.

### Coloring Agent

Examples of the coloring agent include various pigments such as carbon black, Chrome Yellow, Hansa yellow, Benzidine Yellow, Threne Yellow, Quinoline Yellow, Pigment Yellow, Permanent Orange GTR, Pyrazolone Orange, Vulcan Orange, Watchung Red, Permanent Red, Brilliant Carmine 3B, Brilliant Carmine 6B, Dupont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue chloride, Phthalocyanine Blue, Pigment Blue, Phthalocyanine Green, and Malachite Green Oxalate; and various dyes such as acridine-based, xanthene-based, azo-based, benzoquinone-based, azine-based, anthraquinone-based, thioindigo-based, dioxazine-based, thiazine-based, azomethine-based, indigo-based, phthalocyanine-based, aniline black-based, polymethine-based, triphenylmethane-based, diphenylmethane-based, and thiazole-based dyes.

Such coloring agents may be used alone or in combination of two or more thereof.

The coloring agent may be, as needed, a surface-treated coloring agent, or may be used in combination with a dispersing agent. As the coloring agent, plural coloring agents may be used in combination.

The content of the coloring agent is, for example, relative to all the toner particles, preferably 1 mass % or more and 30 mass % or less, more preferably 3 mass % or more and 15 mass % or less.

### Release Agent

Examples of the release agent include hydrocarbon-based waxes; natural waxes such as carnauba wax, rice wax, and candelilla wax; synthetic or mineral or petroleum waxes such as montan wax; and ester-based waxes such as fatty acid esters and montanic acid esters. The release agent is not limited to these.

The release agent has a melting temperature Tm of preferably 50° C. or more and 110° C. or less, more preferably 60° C. or more and 100° C. or less.

Note that the melting temperature is determined, on the basis of a differential scanning calorimetry (DSC) curve obtained by DSC, in accordance with “melting peak temperature” described in “How to determine melting temperature” in JIS K 7121:1987 “Testing Methods for Transition Temperature of Plastics”.

In particular, the release agent has a melting temperature Tm of preferably 65° C. or more and 95° C. or less, more preferably 65° C. or more and 85° C. or less. Use of a release agent having a melting temperature Tm satisfying such a range may facilitate control of the area fraction Sa/St, the area fraction Sb/St, Na, and Nb to the above-described ranges, which may facilitate achievement of both of the releasability of the fixed image and, in the case of continuously forming images in a low-temperature and low-humidity environment, suppression of the decrease in the image density.

A difference Tm−Tg between the melting temperature Tm of the release agent and the glass transition temperature Tg of the binder resin is preferably 15° C. or more and 30° C. or less, more preferably 18° C. or more and 30° C. or less, still more preferably 20° C. or more and 30° C. or less.

Use of a binder resin and a release agent having a difference Tm−Tg satisfying such a range may facilitate control of the area fraction Sa/St, the area fraction Sb/St, Na, and Nb to the above-described ranges, which may facilitate achievement of both of the releasability of the fixed image and, in the case of continuously forming images in a low-temperature and low-humidity environment, suppression of the decrease in the image density.

The term “glass transition temperature Tg of the binder resin” means, in the DSC curve obtained by subjecting the toner to differential scanning calorimetry (DSC), of the endothermic peaks appearing in the temperature region of 30° C. or more and derived from the amorphous resin, the glass transition temperature determined from the highest endothermic peak.

The release agent having a melting temperature satisfying the above-described range is preferably an ester-based wax or a hydrocarbon-based wax, more preferably an ester-based wax.

In particular, in the case of using, as the release agent, an ester-based wax, the release agent may tend to have large diameters and spherical shapes. This may facilitate control of the area fraction Sa/St, the area fraction Sb/St, Na, and Nb to the above-described ranges, which may facilitate achievement of both of the releasability of the fixed image and, in the case of continuously forming images in a low-temperature and low-humidity environment, suppression of the decrease in the image density.

Note that the release agent employed may be, from the viewpoint of reduction in the cost, a single release agent.

The ester-based wax is a wax having an ester bond. The ester-based wax may be a monoester, a diester, a triester, or a tetraester, and can be employed from publicly known natural or synthetic ester waxes.

The ester-based wax may be an ester compound between a higher fatty acid (for example, a fatty acid having 10 or more carbon atoms) and a monohydric or polyhydric aliphatic alcohol (for example, an aliphatic alcohol having 8 or more carbon atoms).

Examples of the ester-based wax include ester compounds between a higher fatty acid (for example, caprylic acid, capric acid, lauric acid, myristic acid, palmitic acid, stearic acid, arachidic acid, behenic acid, or oleic acid) and an alcohol (a monohydric alcohol such as methanol, ethanol, propanol, isopropanol, butanol, capryl alcohol, lauryl alcohol, myristyl alcohol, cetyl alcohol, stearyl alcohol, or oleyl alcohol; or a polyhydric alcohol such as glycerol, ethylene glycol, propylene glycol, sorbitol, or pentaerythritol); specific examples include carnauba wax, rice wax, candelilla wax, jojoba oil, Japan tallow, beeswax, Chinese wax, lanoline, and montanic acid ester wax.

Specific examples of the hydrocarbon-based wax include polyethylene-based waxes, polypropylene-based waxes, polyolefin waxes, Fischer-Tropsch waxes, paraffin-based waxes, and microcrystalline waxes.

The content of the release agent is, for example, relative to all the toner particles, preferably 20 mass % or more and 60 mass % or less, more preferably 30 mass % or more and 50 mass % or less.

### Surfactant

The toner particles may contain a surfactant. The surfactant contained in the toner particles may be, for example, a surfactant that is used, in the process of producing the toner particles, for dispersing the particles in the dispersion liquid and remains within the toner particles.

In particular, the toner particles in which the distribution of release-agent domain diameters is controlled by the above-described opposite-polarity surfactant method contain, for example, both of a cationic surfactant and an anionic surfactant.

Examples of the cationic surfactant include amine acetic acids such as octadecylamine acetic acid salt and tetradecylamine acetic acid salt; methylammonium hydrochloric acid salts such as lauryltrimethylammonium chloride, tallow trimethylammonium chloride, cetyltrimethylammonium chloride, stearyltrimethylammonium chloride, behenyltrimethylammonium chloride, distearyldimethylammonium chloride, and didecyldimethylammonium chloride; benzyl chlorides such as octadecyldimethylbenzylammonium chloride and tetradecyldimethylbenzylammonium chloride; and quaternary ammonium salts such as dioleyldimethylammonium chloride and tetrabutylammonium bromide.

For the cationic surfactant, of these, from the viewpoint of toner particle formability, preferred are quaternary ammonium salts and methylammonium hydrochloric acid salts, and more preferred are quaternary ammonium salts.

Examples of the anionic surfactant include sulfonic acid salts in which at least one of an alkyl group or a phenyl group is substituted with a sulfonic acid salt, such as sodium dodecylbenzenesulfonate and sodium alkyldiphenyl ether disulfonate; metallic soaps such as lithium stearate, magnesium stearate, calcium stearate, barium stearate, zinc stearate, calcium ricinoleate, barium ricinoleate, zinc ricinoleate, and zinc octylate; and alkyl sulfuric acid esters such as lauryl sodium sulfate, lauryl potassium sulfate, myristyl sodium sulfate, and cetyl sodium sulfate.

For the anionic surfactant, of these, from the viewpoint of triboelectric charging, preferred are sulfonic acid salts and metallic soaps, and more preferred are sulfonic acid salts.

Examples of the combination of the cationic surfactant and the anionic surfactant include a combination of a quaternary ammonium salt and a sulfonic acid salt, a combination of a methylammonium hydrochloric acid salt and a sulfonic acid salt, and a combination of a methylammonium hydrochloric acid salt and a metallic soap; of these, preferred is a combination of a quaternary ammonium salt and a sulfonic acid salt.

### Other Additives

Examples of the other additives include well-known additives such as magnetic substances, charge control agents, and inorganic powders. These additives are included, as internal additives, in the toner particles.

### Properties Etc. of Toner Particles

The toner particles in which the opposite-polarity surfactant method is performed to control the distribution of the release-agent domain diameters may be toner particles having, what is called, the core-shell structure constituted by a core portion (core particle) and a cover layer (shell layer) covering the core portion.

The toner particles having the core-shell structure may be constituted by, for example, a core portion including a binder resin, a release agent, and, as needed, another additive such as a coloring agent, and a cover layer including a binder resin and a release agent.

The toner particles having the core-shell structure may be toner particles in which the cover layer including a binder resin and a release agent serves as the outermost layer, or toner particles further including, on the outer circumferential surface of the cover layer including a binder resin and a release agent, another layer. Examples of the other layer include a layer including a binder resin. The other layer may be a layer including a binder resin, but not including a release agent.

Thus, the toner particles having the core-shell structure may be toner particles including a core portion including a binder resin and a release agent, a first cover layer disposed on the outer circumferential surface of the core portion and including a binder resin and a release agent, and a second cover layer disposed on the outer circumferential surface of the first cover layer and including a binder resin.

The toner particles preferably have a volume-average particle diameter (D50v) of 2 μm or more and 10 μm or less, more preferably 4 μm or more and 8 μm or less, still more preferably 5 μm or more and 7 μm or less.

Note that various average particle diameters and various particle size distribution indexes of toner particles are measured using Coulter Multisizer II (manufactured by Beckman Coulter, Inc.) and, as the electrolytic liquid, ISOTON-II (manufactured by Beckman Coulter, Inc.).

During the measurement, into 2 ml of a 5% aqueous solution of a surfactant (preferably sodium alkylbenzene sulfonate) serving as a dispersing agent, 0.5 mg or more and 50 mg or less of the measurement sample is added. This is added to 100 ml or more and 150 ml or less of the electrolytic liquid.

The electrolytic liquid in which the sample is suspended is subjected to a dispersion treatment using an ultrasonic dispersing machine for 1 minute, and Coulter Multisizer II in which the apertures have an aperture diameter of 100 μm is used to measure the particle size distribution of particles having particle diameters of 2 μm or more and 60 μm or less. Note that the number of particles sampled is 50000.

The measured particle size distribution is divided into particle size ranges (channels); over these ranges, volume-based or number-based cumulative distribution curves are drawn from smaller to larger particle diameters; particle diameters corresponding to cumulative values of 16% are defined as volume-based particle diameter D16v and number-based particle diameter D16p; particle diameters corresponding to cumulative values of 50% are defined as volume-average particle diameter D50v and cumulative number-average particle diameter D50p; particle diameters corresponding to cumulative values of 84% are defined as volume-based particle diameter D84v and number-based particle diameter D84p.

These are used to calculate volume-based particle size distribution index (GSDv) as (D84v/D16v)^{1/2} and number-based particle size distribution index (GSDp) as (D84p/D16p)^{1/2}.

The toner particles have an average circularity of preferably 0.94 or more and 1.00 or less, more preferably 0.95 or more and 0.98 or less.

The average circularity of toner particles is determined by (equivalent circular circumference)/(circumference) [(circumference of circle having the same projection area as in image of particle)/(circumference of projection image of particle)]. Specifically, the average circularity is a value measured in the following manner.

First, toner particles to be measured are sampled by suctioning and caused to form a flat flow; a stroboscope is caused to flash momentarily to obtain, as a still picture, the image of particles, and the image of particles is subjected to image analysis using a flow particle image analyzer (FPIA-3000 manufactured by SYSMEX CORPORATION).

The number of particles sampled for determining average circularity is 3500.

Note that, when the toner includes an external additive, the toner (developer) to be measured is dispersed in water containing a surfactant, and subsequently subjected to ultrasonic treatment to obtain toner particles from which the external additive has been removed.

### External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO—SiO₂, K₂O.(TiO₂)n, Al₂O₃.2SiO₂, CaCO₃, MgCO₃, BaSO₄, and MgSO₄.

The surfaces of the inorganic particles serving as an external additive may be subjected to hydrophobic treatment. The hydrophobic treatment is performed by, for example, immersing inorganic particles in a hydrophobizing agent. The hydrophobizing agent is not particularly limited, and examples include silane-based coupling agents, silicone oil, titanate-based coupling agents, and aluminum-based coupling agents. These may be used alone or in combination of two or more thereof.

The amount of hydrophobizing agent is, ordinarily, for example, relative to 100 parts by mass of inorganic particles, 1 part by mass or more and 10 parts by mass or less.

Other examples of the external additive include resin particles (resin particles of polystyrene, polymethyl methacrylate (PMMA), or melamine resin, for example), and cleaning active agents (for example, metallic salts of higher fatty acids represented by zinc stearate and particles of fluoropolymers).

The amount of external additive externally added is, for example, relative to the toner particles, preferably 0.01 mass % or more and 5 mass % or less, more preferably 0.01 mass % or more and 2.0 mass % or less.

### Method for Producing Toner

Hereinafter, a method for producing the toner according to the present exemplary embodiment will be described.

The toner according to the present exemplary embodiment is obtained by, after production of the toner particles, as needed, externally adding an external additive to the toner particles.

Examples of the method for producing the toner particles include dry production methods (for example, a kneading-pulverization method) and wet production methods (for example, an aggregation-coalescence method, a suspension polymerization method, and a dissolution-suspension method).

In the opposite-polarity surfactant method, of these, the aggregation-coalescence method is performed to obtain toner particles.

Specifically, for example, the following steps are performed to produce the toner particles: a step of preparing a resin-particle dispersion liquid in which resin particles that are to serve as a binder resin are dispersed and a release-agent-particle dispersion liquid in which release-agent particles are dispersed (dispersion-liquid preparation step); a step of aggregating, in a dispersion liquid provided by mixing together the resin-particle dispersion liquid and the release-agent-particle dispersion liquid (as needed, in a dispersion liquid provided by further mixing with another particle dispersion liquid), the resin particles and the release-agent particles (and, as needed, other particles), to form first aggregate particles (first-aggregate-particle formation step); a step of further mixing together the first-aggregate-particle dispersion liquid in which the first aggregate particles are dispersed, the resin-particle dispersion liquid in which the resin particles are dispersed, and the release-agent-particle dispersion liquid in which the release-agent particles are dispersed, to cause aggregation such that the resin particles and the release-agent particles further adhere to the surfaces of the first aggregate particles, to form second aggregate particles (second-aggregate-particle formation step); and a step of heating the second-aggregate-particle dispersion liquid in which the second aggregate particles are dispersed, to fuse and coalesce the second aggregate particles, to form toner particles having a core-shell structure having a core portion and a cover layer (fusion-coalescence step).

Hereinafter, the steps will be described in detail.

Note that, in the following descriptions, the method for obtaining toner particles including a coloring agent and a release agent will be described; however, the coloring agent is used as needed. It is appreciated that another additive other than the coloring agent may be used.

### Dispersion-Liquid Preparation Step

First, in addition to a resin-particle dispersion liquid in which resin particles that are to serve as a binder resin are dispersed, for example, a coloring-agent-particle dispersion liquid in which coloring-agent particles are dispersed and a release-agent-particle dispersion liquid in which release-agent particles are dispersed are prepared.

The resin-particle dispersion liquid is prepared by, for example, dispersing resin particles using a surfactant in a dispersion medium.

Examples of the dispersion medium used for the resin-particle dispersion liquid include aqueous media.

Examples of the aqueous media include waters such as distilled water and ion-exchanged water and alcohols. These may be used alone or in combination of two or more thereof.

Examples of the surfactant include anionic surfactants such as sulfuric acid ester salt-based, sulfonic acid salt-based, phosphoric acid ester-based, and soap-based surfactants; cationic surfactants such as amine salt-type and quaternary ammonium salt-type surfactants; and nonionic surfactants such as polyethylene glycol-based, alkylphenol ethylene oxide adduct-based, and polyhydric alcohol-based surfactants. Of these, in particular, anionic surfactants and cationic surfactants may be used. Such a nonionic surfactant may be used in combination with an anionic surfactant or a cationic surfactant.

Such surfactants may be used alone or in combination of two or more thereof.

For the resin-particle dispersion liquid, examples of the method of dispersing resin particles in a dispersion medium include ordinary dispersing methods using a rotary-shearing homogenizer or a media-equipped ball mill, sand mill, or DYNO-MILL, for example. Alternatively, depending on the type of the resin particles, for example, a phase inversion emulsification method may be performed to disperse the resin particles in a resin-particle dispersion liquid.

Note that the phase inversion emulsification method is a method of dissolving the resin to be dispersed, in a hydrophobic organic solvent in which the resin is soluble, adding a base to the organic continuous phase (O phase) to achieve neutralization, and subsequently adding an aqueous medium (W phase) to cause conversion (namely, phase inversion) of the resin from W/O to O/W, to form a discontinuous phase, to achieve dispersing of the resin in the form of particles in the aqueous medium.

The resin particles dispersed in the resin-particle dispersion liquid preferably have a volume-average particle diameter of, for example, 0.01 μm or more and 1 μm or less, more preferably 0.08 μm or more and 0.8 μm or less, still more preferably 0.1 μm or more and 0.6 μm or less.

Note that, for the volume-average particle diameter of the resin particles, a laser diffraction particle size distribution analyzer (such as LA-700 manufactured by HORIBA, Ltd.) is used for measurement to obtain a particle size distribution. The particle size distribution is divided into particle size ranges (channels). Over these channels, a volume-based cumulative distribution curve is drawn from smaller to larger particle diameters. The particle diameter corresponding to a cumulative value of 50% relative to the whole particles is measured as volume-average particle diameter D50v. Note that, similarly, the volume-average particle diameters of particles in other dispersion liquids are also measured.

In the resin-particle dispersion liquid, the resin particle content is, for example, preferably 5 mass % or more and 50 mass % or less, more preferably 10 mass % or more and 40 mass % or less.

Note that, as with the resin-particle dispersion liquid, for example, the coloring-agent-particle dispersion liquid and the release-agent-particle dispersion liquid are also prepared. Specifically, in the resin-particle dispersion liquid, the volume-average particle diameter of the particles, the dispersion medium, the dispersing method, and the particle content also apply to the coloring-agent particles dispersed in the coloring-agent-particle dispersion liquid and the release-agent particles dispersed in the release-agent-particle dispersion liquid.

In the opposite-polarity surfactant method, for example, as the surfactant contained in the resin-particle dispersion liquid, an anionic surfactant is used, as the surfactant contained in the core-particle-forming release-agent-particle dispersion liquid for forming the core portions, a cationic surfactant is used, and, as the surfactant contained in the shell-layer-forming release-agent-particle dispersion liquid for forming the cover layers, an anionic surfactant is used.

Alternatively, as the surfactant contained in the resin-particle dispersion liquid, a cationic surfactant may be used, as the surfactant contained in the core-particle-forming release-agent-particle dispersion liquid, an anionic surfactant may be used, and, as the surfactant contained in the shell-layer-forming release-agent-particle dispersion liquid, a cationic surfactant may be used.

### First-Aggregate-Particle Formation Step

Subsequently, the resin-particle dispersion liquid, the coloring-agent-particle dispersion liquid, and the release-agent-particle dispersion liquid are mixed together.

Note that, in the first-aggregate-particle formation step of forming the core portions of the toner particles having a core-shell structure, for example, as the surfactant contained in the release-agent-particle dispersion liquid, a surfactant is used that has a polarity opposite to that of the surfactant contained in the resin-particle dispersion liquid. This may provide toner particles including large amounts of small-diameter domains in the core portions of the toner particles.

In the mixed dispersion liquid, hetero-aggregation of the resin particles, the coloring-agent particles, and the release-agent particles is caused to form aggregate particles having diameters close to the diameters of the target toner particles and including the resin particles, the coloring-agent particles, and the release-agent particles (first aggregate particles).

Specifically, for example, an aggregating agent is added to the mixed dispersion liquid and the mixed dispersion liquid is adjusted in terms of pH so as to be acidic (such as a pH of 2 or more and 5 or less), and a dispersion stabilizing agent is added as needed; subsequently, the mixed dispersion liquid is heated to a temperature close to the glass transition temperature of the resin particles (specifically, for example, a temperature of “the glass transition temperature of the resin particles—30° C.” or more and “the glass transition temperature—10° C.” or less), to aggregate the particles dispersed in the mixed dispersion liquid, to form the first aggregate particles.

Alternatively, the first-aggregate-particle formation step may be performed in the following manner: for example, under stirring of the mixed dispersion liquid using a rotary-shearing homogenizer, the aggregating agent is added at room temperature (for example, 25° C.), the mixed dispersion liquid is adjusted in terms of pH so as to be acidic (such as a pH of 2 or more and 5 or less), and a dispersion stabilizing agent is added as needed; and, subsequently, the heating is performed.

Examples of the aggregating agent include surfactants having a polarity opposite to that of the surfactant added to the mixed dispersion liquid and used as the dispersing agent, inorganic metal salts, and di- or higher valent metal complexes. In particular, in the case of using, as the aggregating agent, a metal complex, the amount of surfactant used may be reduced and charging characteristics may be improved.

An additive that forms a complex or a similar bond with the metal ion of the aggregating agent may be used as needed. As this additive, a chelating agent may be used.

Examples of the inorganic metal salts include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may be used. Examples of the chelating agent include oxycarboxylic acids such as tartaric acid, citric acid, and gluconic acid; and iminodiacetic acid (IDA), nitrilotriacetic acid (NTA), and ethylenediaminetetraacetic acid (EDTA).

The amount of chelating agent added is, for example, relative to 100 parts by mass of the resin particles, preferably 0.01 parts by mass or more and 5.0 parts by mass or less, more preferably 0.1 parts by mass or more and less than 3.0 parts by mass.

### Second-Aggregate-Particle Formation Step

Subsequently, the first-aggregate-particle dispersion liquid in which the first aggregate particles are dispersed, the resin-particle dispersion liquid in which the resin particles are dispersed, and the release-agent-particle dispersion liquid in which the release-agent particles are dispersed are further mixed together. Subsequently, aggregation is caused such that the resin particles and the release-agent particles further adhere to the surfaces of the first aggregate particles, to form the second aggregate particles including a core portion and a cover layer.

Note that, in the second-aggregate-particle formation step of forming the cover layers of the toner particles having a core-shell structure, for example, as the surfactant contained in the release-agent-particle dispersion liquid, a surfactant is used that has a polarity the same as that of the surfactant contained in the resin-particle dispersion liquid. This may provide toner particles including large amounts of large-diameter domains in the cover layers of the toner particles.

### Fusion-Coalescence Step

Subsequently, the second-aggregate-particle dispersion liquid in which the second aggregate particles are dispersed is heated at, for example, the glass transition temperature or more of the resin particles (for example, not less than a temperature 10 to 30° C. higher than the glass transition temperature of the resin particles), to fuse and coalesce the second aggregate particles, to form toner particles.

The above-described steps are performed to provide toner particles.

Note that the following steps may be performed to produce toner particles: a step of, after the second-aggregate-particle dispersion liquid in which the second aggregate particles are dispersed is obtained, the second-aggregate-particle dispersion liquid and the resin-particle dispersion liquid in which the resin particles are dispersed are further mixed together, to cause aggregation such that the resin particles further adhere to the surfaces of the second aggregate particles, to form the third aggregate particles; and a step of heating the third-aggregate-particle dispersion liquid in which the third aggregate particles are dispersed, to fuse and coalesce the third aggregate particles, to form toner particles including a core portion, a first cover layer, and a second cover layer.

After completion of the fusion-coalescence step, the toner particles formed in the solution are subjected to publicly known steps including a washing step, a solid-liquid separation step, and a drying step to obtain dry toner particles.

As the washing step, from the viewpoint of chargeability, displacement washing using ion-exchanged water may be sufficiently performed. As the solid-liquid separation step, which is not particularly limited, from the viewpoint of productivity, for example, suction filtration or pressure filtration may be performed. As the drying step, which is also not particularly limited in terms of the method, from the viewpoint of productivity, for example, freeze drying, flash drying, fluidized-bed drying, or vibrating fluidized-bed drying may be performed.

The toner according to the present exemplary embodiment is produced by, for example, adding and mixing an external additive with the obtained dry toner particles. The mixing may be performed using, for example, a V blender, a Henschel mixer, or a Loedige mixer. Furthermore, as needed, for example, a vibratory classifier or an air classifier may be used to remove coarse particles from the toner.

### Electrostatic Image Developer

The electrostatic image developer according to the present exemplary embodiment at least includes the toner according to the present exemplary embodiment.

The electrostatic image developer according to the present exemplary embodiment may be a one-component developer including only the toner according to the present exemplary embodiment, or a two-component developer that is a mixture of the toner and a carrier.

The carrier is not particularly limited and may be selected from publicly known carriers. Examples of the carrier include a covered carrier in which the surfaces of cores of a magnetic powder are covered with a cover resin; a magnetic powder dispersed carrier in which a magnetic powder is added so as to be dispersed in a matrix resin; and a resin impregnated carrier in which a porous magnetic powder is impregnated with a resin.

Note that each of the magnetic powder dispersed carrier and the resin impregnated carrier may also be a carrier in which cores that are the particles constituting the carrier are covered with a cover resin.

Examples of the material of the magnetic powder include magnetic metals such as iron, nickel, and cobalt and magnetic oxides such as ferrite and magnetite.

Examples of the cover resin and the matrix resin include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylate copolymers, straight silicone resins containing organosiloxane bonds or modified resins thereof, fluororesins, polyester, polycarbonate, phenolic resins, and epoxy resins.

Note that the cover resin and the matrix resin may contain other additives such as conductive particles.

The conductive particles may be particles of, for example, a metal such as gold, silver, or copper, carbon black, titanium oxide, zinc oxide, tin oxide, barium sulfate, aluminum borate, or potassium titanate.

The process of covering the surfaces of cores with a cover resin may be performed by, for example, dissolving the cover resin and, as needed, various additives in an appropriate solvent to prepare a cover-layer-forming solution and by covering the cores with this solution. The solvent is not particularly limited and may be selected in accordance with, for example, the cover resin used and the coatability.

Specific examples of the covering process with a resin include an immersion process of immersing cores in the cover-layer-forming solution; a spraying process of spraying the cover-layer-forming solution to the surfaces of cores; a fluidized bed process of spraying the cover-layer-forming solution to cores being floated with fluidizing air; and a kneader-coater process of mixing, within a kneader-coater, the cores of a carrier and the cover-layer-forming solution and removing the solvent.

In the two-component developer, the mixing ratio (mass ratio) of the toner to the carrier is preferably toner:carrier=1:100 to 30:100, more preferably 3:100 to 20:100.

### Image Forming Apparatus/Image Forming Method

The image forming apparatus/image forming method according to the present exemplary embodiment will be described.

The image forming apparatus according to the present exemplary embodiment includes an image carrier, a charging section configured to charge the surface of the image carrier, an electrostatic image forming section configured to form, on the charged surface of the image carrier, an electrostatic image, a developing section housing an electrostatic image developer and configured to develop, using the electrostatic image developer, the electrostatic image formed on the surface of the image carrier, to form a toner image, a transfer section configured to transfer, the toner image formed on the surface of the image carrier onto the surface of a recording medium, and a fixing section configured to fix the transferred toner image on the surface of the recording medium. As the electrostatic image developer, the electrostatic image developer according to the present exemplary embodiment is applied.

In the image forming apparatus according to the present exemplary embodiment, an image forming method (the image forming method according to the present exemplary embodiment) including the following steps is performed: a charging step of charging the surface of the image carrier; an electrostatic-image formation step of forming, on the charged surface of the image carrier, an electrostatic image; a development step of developing, using the electrostatic image developer according to the present exemplary embodiment, the electrostatic image formed on the surface of the image carrier, to form a toner image; a transfer step of transferring the toner image formed on the surface of the image carrier onto the surface of a recording medium; and a fixing step of fixing the transferred toner image on the surface of the recording medium.

As the image forming apparatus according to the present exemplary embodiment, a well-known image forming apparatus is applied such as a direct transfer mode apparatus configured to directly transfer a toner image formed on the surface of an image carrier onto a recording medium; an intermediate transfer mode apparatus configured to perform first transfer of the toner image formed on the surface of the image carrier onto the surface of an intermediate transfer body, and to perform second transfer of the transferred toner image on the surface of the intermediate transfer body onto the surface of a recording medium; an apparatus including a cleaning section configured to, after transfer of the toner image, clean the surface (to be charged) of the image carrier; or an apparatus including a discharging section configured to, after transfer of the toner image, irradiate the surface (to be charged) of the image carrier with discharging light to achieve discharging.

In the case of using an intermediate transfer mode apparatus, the transfer section has, for example, a configuration including an intermediate transfer body on the surface of which the toner image is transferred, a first transfer section configured to perform first transfer of the toner image formed on the surface of the image carrier onto the surface of the intermediate transfer body, and a second transfer section configured to perform second transfer of the transferred toner image on the surface of the intermediate transfer body, onto the surface of a recording medium.

Note that, in the image forming apparatus according to the present exemplary embodiment, for example, the part including the developing section may have a cartridge structure (process cartridge) attachable to and detachable from the image forming apparatus. The process cartridge may be, for example, a process cartridge including a developing section housing the electrostatic image developer according to the present exemplary embodiment.

Hereinafter, a non-limiting example of the image forming apparatus according to the present exemplary embodiment will be described. Note that some sections in the drawing will be described, but the other portions will not be described.

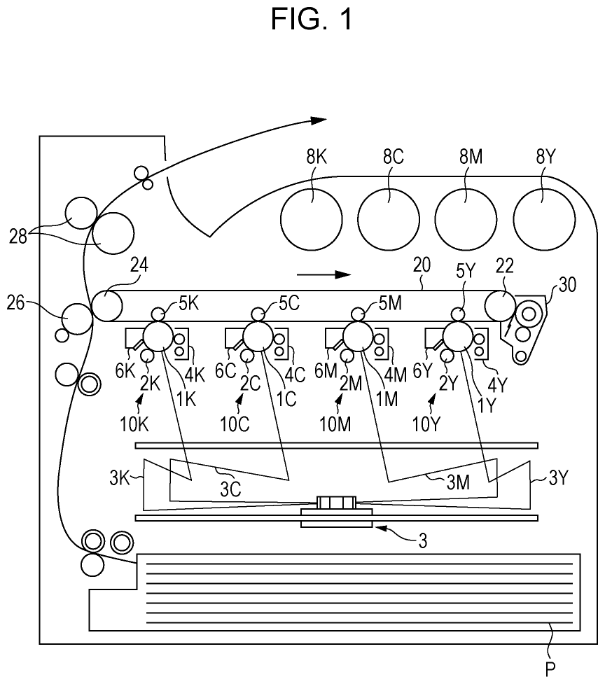

FIG. 1 is a schematic configuration view illustrating the image forming apparatus according to the present exemplary embodiment.

The image forming apparatus in FIG. 1 includes electrophotographic-system first to fourth image formation units 10Y, 10M, 10C, and 10K (image formation sections) configured to output images of individual colors of yellow (Y), magenta (M), cyan (C), and black (K) on the basis of color-separation image data. These image formation units (hereafter, may also be simply referred to as “units”) 10Y, 10M, 10C, and 10K are arranged in the horizontal direction so as to be separated from each other at predetermined intervals. Note that these units 10Y, 10M, 10C, and 10K may be process cartridges attachable to and detachable from the image forming apparatus.

In upper (in the drawing) portions of the units 10Y, 10M, 10C, and 10K, an intermediate transfer belt 20 serving as the intermediate transfer body is disposed so as to extend through the units. The intermediate transfer belt 20 is disposed so as to be wrapped around a driving roller 22 and a support roller 24 (in contact with the inner surface of the intermediate transfer belt 20) (the rollers being disposed so as to be separated from each other in a direction from the left to the right in the drawing) so as to be run in a direction from the first unit 10Y to the fourth unit 10K. Note that the support roller 24 is urged by, for example, a spring (not shown) in a direction away from the driving roller 22, so that the intermediate transfer belt 20 wrapped around the rollers is tensioned. On the image carrier-side surface of the intermediate transfer belt 20, an intermediate-transfer-body cleaning device 30 is disposed so as to face the driving roller 22.

To developing devices (developing sections) 4Y, 4M, 4C, and 4K of the units 10Y, 10M, 10C, and 10K, toners including four-color yellow, magenta, cyan, and black toners housed in toner cartridges 8Y, 8M, 8C, and 8K are supplied.

The first to fourth units 10Y, 10M, 10C, and 10K have the same configuration, and hence the first unit 10Y disposed upstream in the running direction of the intermediate transfer belt and configured to form a yellow image will be described as a representative. Note that elements corresponding to those in the first unit 10Y are denoted by reference signs in which yellow (Y) is replaced by magenta (M), cyan (C), or black (K), and descriptions of the second to fourth units 10M, 10C, and 10K will be omitted.

The first unit 10Y includes a photoreceptor 1Y serving as an image carrier. Around the photoreceptor 1Y, the following are sequentially disposed: a charging roller (an example of the charging section) 2Y configured to charge the surface of the photoreceptor 1Y to a predetermined potential; an exposure device (an example of the electrostatic image forming section) 3 configured to use a laser beam 3Y on the basis of color-separation image signals to expose the charged surface to form an electrostatic image; a developing device (an example of the developing section) 4Y configured to supply the charged toner to the electrostatic image to develop the electrostatic image; a first transfer roller 5Y (an example of the first transfer section) configured to transfer the developed toner image onto the intermediate transfer belt 20; and a photoreceptor cleaning device (an example of the cleaning section) 6Y configured to remove, after the first transfer, the residual toner on the surface of the photoreceptor 1Y.

Note that the first transfer roller 5Y is disposed inside of the intermediate transfer belt 20 and at a position so as to face the photoreceptor 1Y. Furthermore, to each of the first transfer rollers 5Y, 5M, 5C, and 5K, bias power supplies (not shown) configured to apply first transfer biases are individually connected. Each bias power supply applies a transfer bias variable under control by a controller (not shown), to the first transfer roller.

Hereinafter, in the first unit 10Y, the operations of forming a yellow image will be described.

First, before the operations, the charging roller 2Y charges the surface of the photoreceptor 1Y to a potential of −600 V to −800 V.

The photoreceptor 1Y is formed by forming, on a conductive (for example, volume resistivity at 20° C.: 1×10⁻⁶ Ωcm or less) base body, a photosensitive layer. This photosensitive layer has properties of normally having high resistivity (resistivity of ordinary resin), but, upon irradiation with a laser beam 3Y, having laser-beam irradiation portions having a different resistivity. Thus, the charged surface of the photoreceptor 1Y is irradiated with the laser beam 3Y from the exposure device 3 in accordance with the yellow image data transmitted from the controller (not shown). The laser beam 3Y is radiated to the photosensitive layer in the surface of the photoreceptor 1Y; this forms an electrostatic image having the yellow image pattern on the surface of the photoreceptor 1Y.

The electrostatic image is an image formed on the surface of the photoreceptor 1Y by charging: the laser beam 3Y causes a decrease in the resistivity of the irradiated portions of the photosensitive layer where charges flow out from the charged surface of the photoreceptor 1Y while charges of the portions not irradiated with the laser beam 3Y remain, which results in formation of, what is called, a negative latent image.

The electrostatic image formed on the photoreceptor 1Y is rotated together with running of the photoreceptor 1Y to the predetermined development position. At this development position, the electrostatic image on the photoreceptor 1Y is turned into a visual image (developed image) as a toner image by the developing device 4Y.

The developing device 4Y houses therein, for example, an electrostatic image developer including at least a yellow toner and a carrier. The yellow toner is stirred within the developing device 4Y to thereby be frictionally charged, and is held on the developer roller (an example of the developer holding member) so as to have charges having the same polarity (negative polarity) as in the charges on the charged photoreceptor 1Y. While the surface of the photoreceptor 1Y passes over the developing device 4Y, the yellow toner electrostatically adheres to the discharged latent image portions on the surface of the photoreceptor 1Y, so that the latent image is developed with the yellow toner. The photoreceptor 1Y having the yellow toner image formed is continuously run at the predetermined speed, to convey the developed toner image on the photoreceptor 1Y to the predetermined first transfer position.

When the yellow toner image on the photoreceptor 1Y is conveyed to the first transfer, a first transfer bias is applied to the first transfer roller 5Y, and an electrostatic force from the photoreceptor 1Y toward the first transfer roller 5Y affects the toner image, so that the toner image on the photoreceptor 1Y is transferred onto the intermediate transfer belt 20. The transfer bias applied at this time has a polarity (+) opposite to the polarity (−) of the toner, and is controlled to be, for example, +10 μA at the first unit 10Y by a controller (not shown).

On the other hand, the toner remaining on the photoreceptor 1Y is removed by the photoreceptor cleaning device 6Y and collected.

The first transfer biases applied to the first transfer rollers 5M, 5C, and 5K disposed in the second unit 10M and its downstream units are also controlled as in the first unit.

Thus, the intermediate transfer belt 20 onto which the yellow toner image has been transferred at the first unit 10Y is conveyed sequentially through the second to the fourth units 10M, 10C, and 10K, to perform multiple transfer of the toner images of the colors so as to be stacked.

The intermediate transfer belt 20 on which multiple transfer of the toner images of the four colors has been performed at the first to the fourth units reaches a second transfer unit constituted by the intermediate transfer belt 20, the support roller 24 in contact with the inner surface of the intermediate transfer belt, and a second transfer roller (an example of the second transfer section) 26 disposed on the image-holding-surface side of the intermediate transfer belt 20. On the other hand, a recording paper (an example of the recording medium) P is fed at a predetermined timing by a feeding mechanism to the gap where the second transfer roller 26 and the intermediate transfer belt 20 are in contact with each other, and a second transfer bias is applied to the support roller 24. The transfer bias applied at this time has a polarity (−) the same as the polarity (−) of the toner, and the electrostatic force from the intermediate transfer belt 20 toward the recording paper P affects the toner image, to transfer the toner image on the intermediate transfer belt 20 onto the recording paper P. The second transfer bias at this time is determined in response to the resistance of the second transfer unit detected by the resistance detection unit (not shown), and controlled on the basis of voltage.

Subsequently, the recording paper P is sent into the press region (nip) of the pair of fixing rollers in the fixing device (an example of the fixing section) 28, so that the toner image is fixed on the recording paper P, to form a fixed image.

Examples of the recording paper P onto which the toner image is transferred include plain paper used for electrophotographic-system copying machines and printers, for example. Examples of the recording medium include, in addition to the recording paper P, OHP sheets.

In order to further improve the smoothness of the surface of the fixed image, the recording paper P may have a smooth surface and, for example, the coat paper provided by coating the surface of the plain paper with, for example, resin and the art paper for printing may be used.

The recording paper P on which the color image has been fixed is conveyed to the exit unit, and the series of the color image formation operations is completed.

### Process Cartridge/Toner Cartridge

The process cartridge according to the present exemplary embodiment will be described.

The process cartridge according to the present exemplary embodiment is a process cartridge that houses the electrostatic image developer according to the present exemplary embodiment, includes a developing section configured to develop, using the electrostatic image developer, an electrostatic image formed on the surface of an image carrier, to form a toner image, and is attachable to and detachable from an image forming apparatus.

Note that the process cartridge according to the present exemplary embodiment is not limited to the above-described configuration, and may have a configuration including the developing device and, as needed, another section, for example, at least one selected from other sections such as an image carrier, a charging section, an electrostatic image forming section, and a transfer section.

Hereinafter, a non-limiting example of the process cartridge according to the present exemplary embodiment will be described. Note that some sections illustrated in the drawing will be described, but the other portions will not be described.

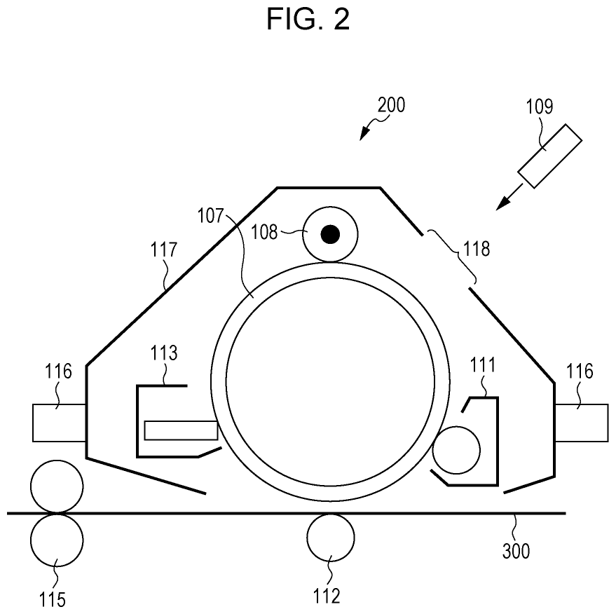

FIG. 2 is a schematic configuration view illustrating the process cartridge according to the present exemplary embodiment.

In a process cartridge 200 in FIG. 2, for example, an attachment rail 116 and a housing 117 having an opening 118 for exposure to light are used to integrally combine and hold a photoreceptor 107 (an example of the image carrier) and a charging roller 108 (an example of the charging section), a developing device 111 (an example of the developing section), and a photoreceptor cleaning device 113 (an example of the cleaning section) that are disposed around the photoreceptor 107, to provide a cartridge.

FIG. 2 illustrates an exposure device 109 (an example of the electrostatic image forming section), a transfer device 112 (an example of the transfer section), a fixing device 115 (an example of the fixing section), and a recording paper 300 (an example of the recording medium).

Hereinafter, the toner cartridge according to the present exemplary embodiment will be described.

The toner cartridge according to the present exemplary embodiment is a toner cartridge including the toner according to the present exemplary embodiment and is attached to and detached from an image forming apparatus. The toner cartridge includes a supplemental toner to be supplied to the developing section disposed within the image forming apparatus.

Note that the image forming apparatus illustrated in FIG. 1 is an image forming apparatus in which the toner cartridges 8Y, 8M, 8C, and 8K are attached and detached, and the developing devices 4Y, 4M, 4C, and 4K are connected to toner cartridges corresponding to the developing devices (colors) via toner supply pipes (not shown). When the toner included in such a toner cartridge is nearly depleted, this toner cartridge is exchanged.

### EXAMPLES

Hereinafter, Examples will be described; however, the present disclosure is not limited at all to these Examples. Note that, in the following descriptions, “part” and “%” are each based on mass unless otherwise specified.

### Preparation of Release-Agent-Particle Dispersion Liquid

### Preparation of Release-Agent-Particle Dispersion Liquid 1

Hydrocarbon-based wax (Fischer-Tropsch wax, manufactured by NIPPON SEIRO CO., LTD., product name: FNP0090, melting temperature Tm: 91° C.): 500 parts
Cationic surfactant (quaternary ammonium salt, compound name: quaternary ammonium salt, manufactured by DAI-ICHI KOGYO SEIYAKU CO., LTD., product name: CATIOGEN™): 16 parts
Ion-exchanged water: 1700 parts

These materials are mixed together and the release agent is heated at an internal liquid temperature of 120° C., and subsequently subjected to dispersion treatment using a pressure-discharge homogenizer (Gaulin homogenizer manufactured by Gaulin company) at a dispersion pressure of 5 MPa for 120 minutes subsequently at 40 MPa until the release-agent particles have a volume-average particle diameter of 225 nm, and to cooling, to obtain a dispersion liquid. Ion-exchanged water is added such that the solid content is adjusted to 20 mass %, and the resultant dispersion liquid is defined as Release-agent-particle dispersion liquid 1. In Release-agent-particle dispersion liquid 1, the release-agent particles are found to have a volume-average particle diameter of 225 nm.

### Preparation of Release-Agent-Particle Dispersion Liquids 2 and 3

The same procedures as in Release-agent-particle dispersion liquid 1 are performed except that the amount of cationic surfactant added is changed as described in Table 1, to obtain Release-agent-particle dispersion liquids 2 and 3. In each of Release-agent-particle dispersion liquids 2 and 3, the release-agent particles are found to have a volume-average particle diameter of 225 nm.

### Preparation of Release-Agent-Particle Dispersion Liquid 4

The same procedures as in Release-agent-particle dispersion liquid 1 are performed except that the cationic surfactant is replaced by an anionic surfactant (sulfonic acid salt, compound name: sodium dodecylbenzenesulfonate, manufactured by DAI-ICHI KOGYO SEIYAKU CO., LTD., product name: Neogen RK) (20 parts), to obtain Release-agent-particle dispersion liquid 4. In Release-agent-particle dispersion liquid 4, the release-agent particles are found to have a volume-average particle diameter of 225 nm.

### Preparation of Release-Agent-Particle Dispersion Liquid 5

The same procedures as in Release-agent-particle dispersion liquid 2 are performed except that paraffin wax FNP0090 is replaced by an ester-based wax (manufactured by NOF CORPORATION, product name: WEP-5, melting temperature Tm: 85° C.) (500 parts), to obtain Release-agent-particle dispersion liquid 5. In Release-agent-particle dispersion liquid 5, the release-agent particles are found to have a volume-average particle diameter of 225 nm.

### Preparation of Release-Agent-Particle Dispersion Liquid 6

The same procedures as in Release-agent-particle dispersion liquid 5 are performed except that the cationic surfactant is replaced by an anionic surfactant (sulfonic acid salt, compound name: sodium dodecylbenzenesulfonate, manufactured by DAI-ICHI KOGYO SEIYAKU CO., LTD., product name: Neogen RK) (20 parts), to obtain Release-agent-particle dispersion liquid 6. In Release-agent-particle dispersion liquid 6, the release-agent particles are found to have a volume-average particle diameter of 225 nm.

TABLE 1

| | | Surfactant | |
|---|---|---|---|
| Release-agent- | | | Amount of |
| particle dispersion | Release agent | | addition (parts |
| liquid | Type | Type | by mass) |
| 1 | Hydrocarbon- | Cationic | 16 |
| | based | | |
| 2 | Hydrocarbon- | Cationic | 20 |
| | based | | |
| 3 | Hydrocarbon- | Cationic | 28 |
| | based | | |
| 4 | Hydrocarbon- | Anionic | 20 |
| | based | | |
| 5 | Ester-based | Cationic | 20 |
| 6 | Ester-based | Anionic | 20 |

### Preparation of Resin-Particle Dispersion Liquids

### Styrene-Acrylic Resin-Particle Dispersion Liquid A

### Preparation of Styrene-Acrylic Resin-Particle Dispersion Liquid A

In a reaction vessel equipped with a stirring device, a temperature sensor, a condenser, and a nitrogen introduction device, 7 parts by mass of an anionic surfactant (sodium dodecyl sulfate) is dissolved in 3000 parts of ion-exchanged water to prepare a surfactant solution. While this surfactant solution is stirred at 230 rpm under a stream of nitrogen, the temperature within the reaction vessel is increased to 80° C.

Subsequently, into the surfactant solution, a polymerization initiator solution in which 9.2 parts of a polymerization initiator (potassium persulfate (KSP)) is dissolved in 200 parts of ion-exchanged water is placed and the temperature within the reaction vessel is set at 75° C.; subsequently, Mixed liquid (1) provided by mixing together the following components is added dropwise over 1 hour.
Styrene: 69.4 parts
n-Butyl acrylate: 28.3 parts
Methacrylic acid: 2.3 parts

Furthermore, the solution provided by dropwise addition of Mixed liquid (1) is stirred at 75° C. for 5 hours to cause polymerization, to prepare Styrene-acrylic resin-particle dispersion liquid A in which Styrene-acrylic resin particles A are dispersed; ion-exchanged water is added such that the solid content is adjusted to 20 mass %.

Styrene-acrylic resin particles A are found to have a weight-average molecular weight of 5500; Styrene-acrylic resin particles A are found to have a volume-average particle diameter of 105 nm.

### Amorphous Polyester Resin-Particle Dispersion Liquid B

### Preparation of Amorphous Polyester Resin B

Terephthalic acid: 70 parts
Fumaric acid: 30 parts
Ethylene glycol: 41 parts
1,5-Pentanediol: 48 parts

Into a 5-liter flask equipped with a stirring device, a nitrogen inlet tube, a temperature sensor, and a rectifying tower, the above-described materials are charged; the temperature is increased, under a stream of nitrogen gas, to 220° C. over 1 hour; relative to 100 parts of the above-described materials, 1 part of titanium tetraethoxide is added. While generated water is driven off, the temperature is increased over 0.5 hours to 240° C.; at the temperature, a dehydration-condensation reaction is continuously caused for 1 hour, and subsequently the reaction product is cooled. In this way, Amorphous polyester resin B having a weight-average molecular weight of 96000 and a glass transition temperature of 61° C. is synthesized.

### Preparation of Amorphous Polyester Resin-Particle Dispersion Liquid B

Into a vessel equipped with a temperature control unit and a nitrogen purging unit, 40 parts of ethyl acetate and 25 parts of 2-butanol are added, to provide a mixed solvent; subsequently, 100 parts of Amorphous polyester resin B is gradually added and dissolved; to this, a 10 mass % aqueous ammonia solution (in an amount corresponding to (in molar ratio) three times the acid value of the resin) is added and stirring is performed for 30 minutes. Subsequently, the vessel is purged with dry nitrogen and kept at a temperature of 40° C.; to the mixed liquid being stirred, 400 parts of ion-exchanged water is added dropwise at a rate of 2 parts/min, to cause emulsification. After completion of dropwise addition, the emulsion is brought back to 25° C., to obtain a resin-particle dispersion liquid in which Amorphous polyester resin particles B having a volume-average particle diameter of 190 nm are dispersed. To the resin-particle dispersion liquid, ion-exchanged water is added such that the solid content is adjusted to 20 mass %, to provide Amorphous polyester resin-particle dispersion liquid B.

### Crystalline Polyester Resin-Particle Dispersion Liquid C

### Preparation of Crystalline Polyester Resin C

1,10-Decane dicarboxylic acid: 265 parts
1,6-Hexanediol: 168 parts
Dibutyl tin oxide (catalyst): 0.3 parts by mass

Into a heat-dried three-neck flask, the above-described components are placed; subsequently, a pressure reduction procedure is performed to turn the atmosphere within the vessel to an inert atmosphere using nitrogen gas; mechanical stirring is performed to perform stirring and reflux at 180° C. for 5 hours. Subsequently, in a reduced pressure, the temperature is increased gradually to 230° C.; stirring is performed for 2 hours; at the time when the content becomes viscous, air-cooling is performed to stop the reaction. As a result of molecular weight measurement (polystyrene equivalent), “Crystalline polyester resin C” is found to have a weight-average molecular weight (Mw) of 12700 and a melting temperature of 73° C.

### Preparation of Crystalline Polyester Resin-Particle Dispersion Liquid C

Crystalline polyester resin C (90 parts by mass), 1.8 parts by mass of ionic surfactant Neogen RK (DAI-ICHI KOGYO SEIYAKU CO., LTD.), and 210 parts by mass of ion-exchanged water are used, heated to 120° C., sufficiently dispersed using ULTRA-TURRAX T50 manufactured by IKA-Werke GmbH & Co. KG, and subsequently subjected to dispersing treatment using a pressure-discharge Gaulin homogenizer for 1 hour, to provide Crystalline polyester resin-particle dispersion liquid C having a volume-average particle diameter of 190 nm and a solid content of 20 mass %.

### Preparation of Coloring-Agent-Particle Dispersion Liquid

Carbon black (manufactured by Cabot Corporation, Regal 330): 50 parts
Ionic surfactant Neogen RK (DAI-ICHI KOGYO SEIYAKU CO., LTD.): 5 parts
Ion-exchanged water: 193 parts

These components are mixed together and treated with an Ultimaizer (manufactured by Sugino Machine Limited) at 240 MPa for 60 minutes, to prepare a coloring-agent-particle dispersion liquid (solid content concentration: 20 mass %).

### Preparation of Toner Particles

### Example 1

Styrene-acrylic resin-particle dispersion liquid A: 360 parts
Amorphous polyester resin-particle dispersion liquid B: 40 parts
Crystalline polyester resin-particle dispersion liquid C: 40 parts
Coloring-agent-particle dispersion liquid: 250 parts Ion-exchanged water: 1100 parts

These components and 350 parts of Release-agent-particle dispersion liquid 3 are sufficiently mixed and dispersed within a round-bottom stainless steel flask using ULTRA-TURRAX T50, to obtain a solution. Subsequently, to this solution, 50 parts by mass of a 1 mass % aqueous aluminum sulfate solution is added, to prepare core aggregate particles as the first aggregate particles; ULTRA-TURRAX is used to perform dispersion at 7000 rpm for 5 minutes.

Furthermore, the solution within the flask under stirring in a heating oil bath is heated to 52° C., and kept at 52° C. for 60 minutes; subsequently, to this, a mixed liquid of 130 parts of Amorphous polyester resin-particle dispersion liquid B, 150 parts of Release-agent-particle dispersion liquid 4, and 100 parts of ion-exchanged water is added over 10 minutes, to prepare the second aggregate particles having a core-shell structure.

Subsequently, a 0.5 Mol/L aqueous sodium hydroxide solution is added to adjust the pH of the solution to 8.5; subsequently, the stainless steel flask is sealed; while a magnetic sealing device is used to perform stirring continuously, the solution is heated to 98° C., kept for 30 minutes, cooled to 90° C. over 15 minutes, and subsequently cooled, using cold water, at a cooling rate of 8° C./min, to 30° C. to obtain black toner particles having a volume-average particle diameter of 6.1 μm. For the obtained toner particles, in Table 2, the styrene content (“Styrene amount” in Table) and Tm−Tg will be described.

### Examples 2 to 6

The same procedures as in Example 1 are performed except that the type and addition amount of the release-agent-particle dispersion liquid used during preparation of the first aggregate particles are changed from Release-agent-particle dispersion liquid 3 and 350 parts to the types and addition amounts described in Table 2 (“WAX (core)” in Table) and the type and addition amount of the release-agent-particle dispersion liquid used during preparation of the second aggregate particles are changed from Release-agent-particle dispersion liquid 4 and 5 parts to the types and addition amounts described in Table 2 (“WAX (shell)” in Table), to obtain black toner particles. For the obtained toner particles, in Table 2, the volume-average particle diameters (“Toner particle diameter” in Table), the styrene contents (“Styrene amount” in Table), and Tm−Tg will be described.

### Example 7

The same procedures as in Example 4 are performed except that the addition amount of Styrene-acrylic resin particle dispersion liquid A is changed from 360 parts to 400 parts, the addition amount of Amorphous polyester resin-particle dispersion liquid B is changed from 40 parts to 20 parts, and the addition amount of Crystalline polyester resin-particle dispersion liquid C is changed from 40 parts to 20 parts, to obtain a black toner. For the obtained toner particles, in Table 2, the volume-average particle diameter (“Toner particle diameter” in Table), the styrene content (“Styrene amount” in Table), and Tm−Tg will be described.

### Example 8

The same procedures as in Example 4 are performed except that the addition amount of Styrene-acrylic resin particle dispersion liquid A is changed from 360 parts to 320 parts, the addition amount of Amorphous polyester resin-particle dispersion liquid B is changed from 40 parts to 60 parts, and the addition amount of Crystalline polyester resin-particle dispersion liquid C is changed from 40 parts to 60 parts, to obtain a black toner. For the obtained toner particles, in Table 2, the volume-average particle diameter (“Toner particle diameter” in Table), the styrene content (“Styrene amount” in Table), and Tm−Tg will be described.

### Comparative Examples 1 to 3

The same procedures as in Example 1 are performed except that the type and addition amount of the release-agent-particle dispersion liquid used during preparation of the first aggregate particles are changed from Release-agent-particle dispersion liquid 3 and 350 parts to the types and addition amounts described in Table 2 (“WAX (core)” in Table) and the type and addition amount of the release-agent-particle dispersion liquid used during preparation of the second aggregate particles are changed from Release-agent-particle dispersion liquid 4 and 5 parts to the types and addition amounts described in Table 2 (“WAX (shell)” in Table), to obtain black toner particles. For the obtained toner particles, in Table 2, the volume-average particle diameters (“Toner particle diameter” in Table), the styrene contents (“Styrene amount” in Table), and Tm−Tg will be described.

### Measurement of Release-Agent Domains

For the obtained toner particles, Table 3 describes the results of determining, by the above-described methods, the area fraction Sa/St, area fraction Sb/St, area fraction Sc/St, area fraction Sw/St, Na, Nb, Nc, and average circularity of large-diameter domains (“Circularity” in Table).

### Preparation of Toners

Such obtained toner particles (100 parts) and 0.7 parts of dimethyl silicone oil-treated silica particles (RY200, manufactured by NIPPON AEROSIL CO., LTD.) are mixed together with a Henschel mixer, to obtain toners.

### Preparation of Developers

Such an obtained toner (8 parts) and 100 parts of the following carrier are mixed together, to obtain developers.

### Preparation of Carrier

Ferrite particles (average particle diameter: 50 μm): 100 parts
Toluene: 14 parts
Styrene/methyl methacrylate copolymer (copolymerization ratio: 15/85): 3 parts
Carbon black: 0.2 parts

These components except for the ferrite particles are dispersed using a sand mill to prepare a dispersion liquid; this dispersion liquid is placed, together with the ferrite particles, into a vacuum deairing kneader, and subjected to a reduction in the pressure under stirring to perform drying, to thereby obtain a carrier.

### Evaluations

### Evaluation of Image Density

Such an obtained developer is used, in a modified version of DocuCentre Color 400 manufactured by FUJIFILM Business Innovation Corp., to print, in a low-temperature low-humidity environment at an indoor temperature of 10° C. and at a relative humidity of 15%, on 50,000 A4-sized coat paper sheets, a test chart image having an area coverage of 5%; the difference between the image density in the 1,000th sheet and the image density in the 50,000th sheet is determined and evaluated. Specifically, a color spectrophotometer (X-Rite Ci62, manufactured by X-Rite Inc.) is used to measure, at randomly selected three points in such an image, L* values, a* values, and b* values, and color difference ΔE is determined and evaluated by being graded into one of the following grades. Note that grades A to D are acceptable grades. The results will be described in Table 3.

### Evaluation Grades

A: The color difference ΔE is 1 or less and does not cause problems.

B: The color difference ΔE is more than 1 and 2 or less. The density difference is small and does not cause problems.

C: The color difference ΔE is more than 2 and 3 or less. The density difference is present, but is acceptable.

D: The color difference ΔE is more than 3 and 5 or less. The density difference is present, but is acceptable.

E: The color difference ΔE is more than 5. This is problematic.

### Evaluation of Fixability

Such an obtained developer is used, in a modified version of DocuCentre Color 400 manufactured by FUJIFILM Business Innovation Corp. in an environment at 28° C. and at 85% RH, to output, on 10000 A4-sized J paper sheets (manufactured by Fuji Xerox Co., Ltd.), an image having an area coverage of 20%. Note that the fixing temperature is set at 180° C. The image on the 10000th sheet is visually inspected and evaluated in terms of the presence or absence of offset on the basis of evaluation grades below. Note that grades A to C are acceptable grades. The results will be described in Table 3.

### Evaluation Grades

A: not observed.

B: offset occurs in less than 1% of the area of the image.

C: offset occurs in 1% or more and less than 10% of the area of the image.

D: offset occurs in 10% or more and less than 15% of the area of the image.

E: offset occurs in 15% or more of the area of the image.

TABLE 2

| | WAX (core) | | WAX (shell) | | Styrene | | Toner |
|---|---|---|---|---|---|---|---|
| | | A- | | A- | (mass | Tm- | particle |
| | | mount | | mount | %) | Tg | diameter |
| | Type | (parts) | Type | (parts) | amount | (° C.) | (μm) |
| Example 1 | 3 | 350 | 4 | 150 | 19 | 28 | 6.1 |
| Example 2 | 2 | 350 | 4 | 150 | 19 | 27 | 6.1 |
| Example 3 | 1 | 350 | 4 | 150 | 19 | 27 | 6.1 |
| Example 4 | 5 | 350 | 6 | 150 | 19 | 23 | 6.2 |
| Example 5 | 5 | 490 | 6 | 210 | 16 | 20 | 6.3 |
| Example 6 | 5 | 210 | 6 | 90 | 22 | 23 | 5.9 |
| Example 7 | 5 | 350 | 6 | 150 | 21 | 24 | 6.0 |
| Example 8 | 5 | 350 | 6 | 150 | 17 | 23 | 6.2 |
| Comparative | 4 | 350 | 4 | 150 | 19 | 25 | 6.1 |
| Example 1 | | | | | | | |
| Comparative | 6 | 350 | 6 | 150 | 19 | 24 | 6.3 |
| Example 2 | | | | | | | |
| Comparative | 5 | 350 | 5 | 150 | 19 | 23 | 5.9 |
| Example 3 | | | | | | | |

TABLE 3

| | Release-agent domains | | | | | | | | | | Evaluations | |
|---|---|---|---|---|---|---|---|---|---|---|---|---|
| | Sa/St | Sb/St | Sc/St | | Na | Nb | Nc | | Sw/St | | Image | |
| | (%) | (%) | (%) | Sb/Sa | (number) | (number) | (number) | Nb/Na | (%) | Circularity | density | Fixability |
| Example 1 | 2.2 | 36.5 | 1.7 | 16.5 | 17.0 | 4.7 | 0.9 | 0.28 | 40.5% | 0.68 | B | B |
| Example 2 | 5.3 | 33.2 | 2.6 | 6.3 | 28.9 | 3.5 | 0.8 | 0.12 | 41.1% | 0.77 | A | B |
| Example 3 | 18.5 | 22.7 | 3.9 | 1.2 | 43.0 | 3.1 | 1.2 | 0.07 | 45.1% | 0.79 | B | C |
| Example 4 | 5.4 | 32.9 | 1.6 | 6.1 | 23.2 | 3.9 | 0.6 | 0.17 | 39.9% | 0.95 | A | A |
| Example 5 | 7.0 | 36.3 | 4.6 | 5.2 | 31.0 | 4.4 | 1.5 | 0.14 | 47.9% | 0.93 | C | B |
| Example 6 | 2.9 | 25.7 | 1.9 | 8.8 | 21.0 | 3.1 | 0.8 | 0.15 | 30.5% | 0.97 | B | B |
| Example 7 | 16.3 | 24.9 | 2.8 | 1.5 | 38.5 | 3.1 | 1.4 | 0.08 | 44.0% | 0.94 | C | C |
| Example 8 | 4.5 | 33.8 | 1.8 | 7.5 | 20.7 | 3.8 | 0.8 | 0.18 | 40.1% | 0.94 | C | B |
| Comparative | 0.1 | 43.0 | 1.6 | 711.1 | 1 | 4 | 0.6 | 4.00 | 44.7% | 0.72 | E | E |
| Example 1 | | | | | | | | | | | | |
| Comparative | 0 | 42.4 | 0.6 | — | 0 | 5.2 | 0.5 | — | 43.1% | 0.95 | D | E |
| Example 2 | | | | | | | | | | | | |
| Comparative | 33.8 | 0 | 6.8 | 0 | 49.0 | 0 | 1.2 | 0 | 40.6% | 0.97 | E | D |
| Example 3 | | | | | | | | | | | | |

The results have demonstrated that the toners according to Examples achieve both of the releasability of the fixed image and, in the case of continuously forming images in a low-temperature and low-humidity environment, suppression of the decrease in the image density.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An electrostatic image developing toner comprising toner particles containing a binder resin and a release agent,
wherein, in sections of the toner particles in which the sections of the toner particles have an area St in total and, among sections of domains of the release agent, sections of domains having long diameters of 10 nm or more and 500 nm or less have a total area Sa and sections of domains having long diameters of 1500 nm or more and 3000 nm or less have a total area Sb, an area fraction Sa/St is 2% or more and an area fraction Sb/St is 20% or more.

2. The electrostatic image developing toner according to claim 1, wherein a ratio Sb/Sa of Sb to Sa is 1 or more and 20 or less.

3. The electrostatic image developing toner according to claim 1, wherein the area fraction Sa/St is 20% or less and the area fraction Sb/St is 40% or less.

4. An electrostatic image developing toner comprising toner particles containing a binder resin and a release agent,
wherein, per section of one of the toner particles in which, among sections of domains of the release agent, a number of sections of domains having long diameters of 10 nm or more and 500 nm or less is Na and a number of sections of domains having long diameters of 1500 nm or more and 3000 nm or less is Nb, Na is 15 or more and Nb is 3 or more.

5. The electrostatic image developing toner according to claim 4, wherein a ratio Nb/Na of Nb to Na is 0.05 or more and 0.30 or less.

6. The electrostatic image developing toner according to claim 4, wherein Na is 45 or less and Nb is 5 or less.

7. The electrostatic image developing toner according to claim 1, wherein, in the sections of the toner particles in which the sections of the toner particles have the area St in total and the sections of domains of the release agent have a total area Sw, an area fraction Sw/St is 30% or more and 50% or less.

8. The electrostatic image developing toner according to claim 1, wherein the sections of domains having long diameters of 1500 nm or more and 3000 nm or less have an average circularity of 0.6 or more.

9. The electrostatic image developing toner according to claim 1, wherein the release agent has a melting temperature Tm of 65° C. or more and 95° C. or less.

10. The electrostatic image developing toner according to claim 9, wherein the release agent is an ester-based wax.

11. The electrostatic image developing toner according to claim 1, wherein the binder resin includes a styrene-(meth)acrylic resin.

12. The electrostatic image developing toner according to claim 11, wherein, relative to a total mass of the toner particles, a content of a unit derived from a monomer having a styrene skeleton is 15 mass % or more and 25 mass % or less.

13. The electrostatic image developing toner according to claim 1, wherein a difference Tm−Tg between a melting temperature Tm of the release agent and a glass transition temperature Tg of the binder resin is 15° C. or more and 30° C. or less.

14. The electrostatic image developing toner according to claim 1, wherein the toner particles contain a cationic surfactant and an anionic surfactant.

15. The electrostatic image developing toner according to claim 14, wherein the cationic surfactant is a quaternary ammonium salt and the anionic surfactant is a sulfonic acid salt.

16. An electrostatic image developer comprising the electrostatic image developing toner according to claim 1.

17. A toner cartridge comprising the electrostatic image developing toner according to claim 1,
wherein the toner cartridge is attachable to and detachable from an image forming apparatus.

18. A process cartridge comprising a developing section housing the electrostatic image developer according to claim 16 and configured to develop, using the electrostatic image developer, an electrostatic image formed on a surface of an image carrier, to form a toner image,
wherein the process cartridge is attachable to and detachable from an image forming apparatus.

19. An image forming apparatus comprising:
an image carrier;
a charging section configured to charge a surface of the image carrier;
an electrostatic image forming section configured to form, on the charged surface of the image carrier, an electrostatic image;
a developing section housing the electrostatic image developer according to claim 16 and configured to develop, using the electrostatic image developer, the electrostatic image formed on the surface of the image carrier, to form a toner image;
a transfer section configured to transfer the toner image formed on the surface of the image carrier onto a surface of a recording medium; and
a fixing section configured to fix the transferred toner image on the surface of the recording medium.

20. An image forming method comprising:
charging a surface of an image carrier;
forming an electrostatic image on the charged surface of the image carrier;
developing, using the electrostatic image developer according to claim 16, the electrostatic image formed on the surface of the image carrier, to form a toner image;
transferring the toner image formed on the surface of the image carrier onto a surface of a recording medium; and
fixing the transferred toner image on the surface of the recording medium.
